(19) United States
(12) Patent Application Publication
(10) Pub. No.: US 2026/0346631 A1
(43) Pub. Date: Nov. 5, 2026

(54) INK SET AND IMAGE FORMING METHOD

(71) Applicant: Konica Minolta, Inc., Tokyo (JP)

(72) Inventors: Kenichiro HOSAKA, Tokyo (JP); Yoshihito TAGUCHI, Kanagawa (JP); Masashi IKEDA, Tokyo (JP); Yorihiro YAMAYA, Tokyo (JP); Shogo WATANABE, Tokyo (JP)

(21) Appl. No.: 19/533,448

(22) Filed: Feb. 9, 2026

(30) Foreign Application Priority Data
Feb. 17, 2025 (JP) 2025-023656
Feb. 17, 2025 (JP) 2025-023662

(51) Int. Cl. B41M 7/00

(52) U.S. Cl. CPC B41M 7/0081

(57) ABSTRACT

An image forming method of a first disclosure includes a step of ejecting an inkjet ink onto a recording medium, and a step of curing the inkjet ink, which is ejected onto the recording medium being conveyed, by irradiating the inkjet ink with active rays in an active ray irradiation region. In the step of curing the inkjet ink, when the active ray irradiation region is divided into two in a central portion thereof in the conveyance direction of the recording medium, the inkjet ink is irradiated with the active rays in such a way that an integrated light amount of the active rays in a downstream portion of the active ray irradiation region is greater than an integrated light amount of the active rays in an upstream portion of the active ray irradiation region.

### CROSS REFERENCE TO RELATED APPLICATIONS

The entire disclosures of Japanese Patent Application No. 2025-23656 filed on Feb. 17, 2025 and Japanese Patent Application No. 2025-23662 filed on Feb. 17, 2025 are incorporated herein by reference in its entirety.

### BACKGROUND

### Technological Field

The present invention relates to an image forming method.

### Description of Related Art

An image forming method using an inkjet method is used in various fields because an image can be formed easily and inexpensively. As an inkjet image forming method, a method is known in which an inkjet ink is landed on a recording medium and then irradiated with active rays to cure the inkjet ink (for example, see International Publication No. 2013/161328 (PTL 1)).

In recent years, in the field of digital commercial printing using active ray curable inkjet ink, increasing the conveyance speed of a recording medium has been studied from the viewpoint of improving productivity. In inkjet printing, as the conveyance speed of a recording medium increases, the time from landing of an inkjet ink to completion of irradiation with active rays decreases, so that high pinning performance is required.

PTL 1 describes an image forming method in which an active ray curable inkjet ink is landed on a recording medium and then irradiated with ultraviolet rays to cure the active ray curable inkjet ink.

In the image forming method described in PTL 1, a gelling agent is added to an active ray curable inkjet ink to enhance the pinning performance. In addition, the emitted ultraviolet rays have a unimodal irradiation distribution in the conveyance direction of the recording medium.

### SUMMARY

However, in the image forming method described in PTL 1, the amount of the gelling agent added to the active ray curable inkjet ink limits the effect of the gelling agent from the viewpoint of the compatibility between the gelling agent and other materials and the ejection viscosity of the inkjet ink. Furthermore, in the image forming method described in PTL 1, there is room for study on the pinning performance of an active ray curable inkjet ink in the case where the conveyance speed of a recording medium has become faster as in recent years. In the image formed on the recording medium in such a manner, the inside of the inkjet ink is not cured in some cases, and post-processing such as cutting processing cannot be performed after the image formation.

An object of a first disclosure is to provide an image forming method capable of appropriately performing post-processing regardless of the conveyance speed of a recording medium.

### Solution to Problem

An image forming method according to a first disclosure is an image forming method for forming, by using an inkjet ink of an active ray-curable type, an image on a recording medium conveyed from upstream to downstream, the inkjet ink containing a polymerizable compound, a photopolymerization initiator, and a gelling agent and undergoing phase transition depending on a temperature. The image forming method includes: ejecting the inkjet ink onto the recording medium; and curing the inkjet ink by irradiating the inkjet ink with an active ray in an active ray irradiation region, the inkjet ink being ejected onto the recording medium being conveyed. In the curing the inkjet ink, when the active ray irradiation region is divided into two at a central portion of the active ray irradiation region in a conveyance direction of the recording medium, the active ray is applied in such a way that an integrated amount of the active ray in a downstream portion of the active ray irradiation region is larger than an integrated amount of the active ray in an upstream portion of the active ray irradiation region.

### Advantageous Effects of Invention

According to the present invention, it is possible to provide an image forming method capable of appropriately performing post-processing regardless of the conveyance speed of a recording medium.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a flowchart illustrating an example of an image forming method, and

FIGS. 2A to 2C are schematic irradiance distributions for explaining an example of the integrated light amount, and

FIG. 3 is a schematic diagram illustrating an example of the image forming apparatus;

FIG. 4 is a flowchart illustrating another example of the image forming method; and

FIG. 5 is a schematic diagram illustrating another example of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, the present disclosure will be described in detail with reference to the accompanying drawings. In each disclosure, first, an inkjet ink will be described, and then an image forming method and an image forming apparatus using the inkjet ink will be described.

### First Disclosure

### 1. Inkjet Ink

The inkjet ink is an active ray curable inkjet ink (i.e., inkjet ink of an active ray-curable type) and contains a photopolymerizable compound, a photopolymerization initiator, and a gelling agent.

### 1-1. Photopolymerizable Compound

The photopolymerizable compound is a compound which is crosslinked or polymerized by irradiation with active rays. The photopolymerizable compound may be used alone or in combination of two or more types thereof.

The photopolymerizable compound is a radically polymerizable compound or a cationically polymerizable compound, and a radically polymerizable compound is preferable.

The radically polymerizable compound is a compound (a monomer, an oligomer, a polymer, or a mixture thereof) having a radically polymerizable ethylenically unsaturated bond. The radically polymerizable compounds may be used alone or in combination of two or more types thereof.

Examples of the compound having a radically polymerizable ethylenically unsaturated bond include unsaturated carboxylic acids and salts thereof, unsaturated carboxylic acid ester compounds, unsaturated carboxylic acid urethane compounds, unsaturated carboxylic acid amide compounds, acrylonitrile, styrene, unsaturated polyesters, unsaturated polyethers, unsaturated polyamides, and unsaturated urethanes. Examples of the unsaturated carboxylic acid include (meth)acrylic acids, itaconic acid, crotonic acid, isocrotonic acid, and maleic acid.

The radically polymerizable compound is preferably an unsaturated carboxylic acid ester compound, and more preferably a (meth)acrylate compound. The (meth)acrylate compound may be a monomer, an oligomer, a mixture of a monomer and an oligomer, a modified product, an oligomer having a polymerizable functional group, or the like. The (meth)acrylate compound may be used alone or in combination of two or more types thereof. From the viewpoint of enhancing curability, the (meth)acrylate compound preferably has two or more (meth)acrylate groups in one molecule.

From the viewpoint of enhancing compatibility with a highly hydrophobic gelling agent, the (meth)acrylate compound preferably contains a (meth)acrylate compound having a C log P value of 4.0 to 7.0. The (meth)acrylate compound having a C log P value of 4.0 to 7.0 is preferably a tri- or higher functional (meth)acrylate compound having a structure represented by (—C(CH₃)H—CH₂—O—)ₘ (m is an integer of 3 to 14) in the molecule thereof, or a di- or higher functional (meth)acrylate compound having a cyclic structure in the molecule thereof. Since a (meth)acrylate compound has high photocurability and is less prone to cure shrinkage, it can increase the reproducibility of the sol-gel phase transition.

The tri- or higher functional (meth)acrylate compound having a structure represented by (—C(CH₃)H—CH₂—O—)ₘ (m is an integer of 3 to 14) in the molecule thereof is a compound obtained by modifying hydroxyl groups of a compound having three or more hydroxyl groups with propylene oxide and esterifying the obtained modified product with a (meth)acrylic acid. An example of such a compound includes 3PO modified trimethylolpropane triacrylate Photomer 4072 (molecular weight 471, C log P 4.90, manufactured by Cognis). In addition, examples of the compound include 3PO modified trimethylolpropane triacrylate Miramer M360 (molecular weight 471, C log P 4.90, manufactured by Miwon).

Examples of the di- or higher functional (meth)acrylate compound having a cyclic structure in the molecule thereof include a compound obtained by esterifying hydroxyl groups of a compound having two or more hydroxyl groups and tricycloalkane with a (meth)acrylic acid. Examples of such compounds include tricyclodecane dimethanol diacrylate NK ester A-DCP (molecular weight 304, C log P 4.69) and tricyclodecane dimethanol dimethacrylate NK ester DCP (molecular weight 332, C log P 5.12). In addition, examples of the compound include 1,10-decanediol dimethacrylate NK ester DOD-N (molecular weight of 310, C log P 5.75, manufactured by Shin-Nakamura Chemical Co., Ltd). In addition, examples of the compound include nonylphenol 8EO modified acrylate Miramer M166 (C log P 6.42, manufactured by Miwon).

The C log P value of these (meth)acrylate compounds is preferably in a range of 4.0 to 7.0, and more preferably in a range of 4.5 to 6.0. When the C log P value is less than 4.0, the inkjet ink containing such a compound exhibits hydrophilicity, and therefore a hydrophobic gelling agent is less likely to be dissolved. In the inkjet ink containing such a compound, it may be difficult to completely dissolve the gelling agent even by heating. On the other hand, when the C log P value is more than 7.0, the solubility of a photopolymerization initiator or an initiation auxiliary agent in an inkjet ink is more likely to be reduced, and thus the curability is more likely to be reduced or the ejection stability is more likely to be reduced.

The content of the (meth)acrylate compound having a C log P value in the range of 4.0 to 7.0 in the inkjet ink is preferably in the range of 10 to 40% by mass and more preferably in the range of 15 to 35% by mass. When the content of the (meth)acrylate compound is less than 10% by mass, the inkjet ink exhibits hydrophilicity, and therefore, the solubility of a hydrophobic gelling agent is more likely to be reduced. On the other hand, when the content of the (meth)acrylate compound is greater than 40% by mass, curing shrinkage of ink droplets is more likely to occur, and printed matter is more likely to be curled. Therefore, the image is more likely to be cracked when the image is bent.

The (meth)acrylate compound may include another (meth)acrylate compound. Examples of the other (meth)acrylate compounds include ethylene oxide-modified (meth)acrylate compounds. An ethylene oxide-modified (meth)acrylate compound has high photosensitivity, and tends to form a card house structure described below when gelled at a low temperature.

Examples of the ethylene oxide-modified (meth)acrylate compound include 4EO modified hexanediol diacrylate CD561 (molecular weight of 358) and 3EO modified trimethylolpropane triacrylate SR454 (molecular weight of 429) manufactured by Sartomer Company, Inc. Examples of the compound include 6EO modified trimethylolpropane triacrylate SR499 (molecular weight of 560) and 4EO modified pentaerythritol tetraacrylate SR494 (molecular weight of 528). Furthermore, examples of the compound include polyethylene glycol diacrylate NK Ester A-400 (molecular weight of 508) and NK Ester A-600 (molecular weight of 742) manufactured by Shin-Nakamura Chemical Co., Ltd. Examples of the compound include polyethylene glycol dimethacrylate NK Ester 9G, NK Ester 14G, and tetraethylene glycol diacrylate V #335HP manufactured by Osaka Organic Chemical Industry Ltd.

The molecular weight of the photopolymerizable compound contained in the active ray curable inkjet ink is preferably in a range of 280 to 1500 and more preferably in a range of 300 to 800. This is because an inkjet ink containing a photopolymerizable compound having a molecular weight of less than 280 and a gelling agent undergoes an excessively large change in viscosity of the vicinity of the ejection temperature. On the other hand, an inkjet ink containing a photopolymerizable compound having a molecular weight of more than 1500 and a gelling agent has too high sol viscosity, and thus is not suitable as an inkjet ink.

The total content of the photopolymerizable compounds in the inkjet ink is preferably in a range of 1 to 97% by mass, and more preferably in a range of 30 to 95% by mass.

### 1-2. Gelling Agent

The gelling agent has a function of causing the inkjet ink to undergo a sol-gel phase transition reversibly depending on a temperature. The gelling agent is required to be dissolved in the photopolymerizable compound or the like at least at a temperature higher than the gelation temperature and to be crystallized in the inkjet ink at a temperature equal to or lower than the gelation temperature.

When the gelling agent crystallizes in the inkjet ink, it is preferable that the plate-shaped crystals of the gelling agent form a three-dimensionally surrounding space, and the photopolymerizable compound is enclosed in the space. Such a structure in which a photopolymerizable compound is enclosed in a space three dimensionally surrounded by a plate crystal may be referred to as a “card house structure”. When the card house structure is formed, the liquid photopolymerizable compound can be retained and the inkjet ink can be pinned. Thus, coalescence of the liquid droplets can be suppressed.

In order to form the card house structure, it is preferable that the photopolymerizable compound and the gelling agent dissolved in the inkjet ink in a sol state are compatible with each other. In contrast, when the photopolymerizable compound and the gelling agent dissolved in the inkjet ink in a sol state are phase-separated, it may be difficult to form the card house structure.

Examples of the gelling agent include aliphatic ketone compounds; aliphatic ester compounds; petroleum-based waxes such as paraffin wax, microcrystalline wax, and petrolatum; vegetable waxes such as candelilla wax, carnauba wax, rice wax, Japan wax, jojoba oil, jojoba solid wax, and jojoba esters; animal waxes such as beeswax, lanolin and spermaceti; Mineral waxes such as montan wax and hydrogenated wax; hydrogenated castor oil or a hydrogenated castor oil derivative; modified waxes such as montan wax derivatives, paraffin wax derivatives, microcrystalline wax derivatives, or polyethylene wax derivatives; higher fatty acids such as behenic acid, arachidic acid, stearic acid, palmitic acid, myristic acid, lauric acid, oleic acid, and erucic acid; higher alcohols such as stearyl alcohol and behenyl alcohol; Hydroxystearic acid such as 12-hydroxystearic acid; 12-hydroxystearic acid derivatives; fatty acid amides such as lauric acid amide, stearic acid amide, behenic acid amide, oleic acid amide, erucic acid amide, ricinoleic acid amide, and 12-hydroxystearic acid amide (e.g., Nikkaamide series manufactured by Nippon Kasei Chemical Co., Ltd., ITOWAX series manufactured by Itoh Oil Chemicals Co., Ltd., FATTYAMID series manufactured by Kao Corporation, etc); N-substituted fatty acid amides such as N-stearyl stearic acid amide and N-oleyl palmitic acid amide; Special fatty acid amides such as N,N′-ethylenebisstearylamide, N,N′-ethylenebis-12-hydroxystearylamide, and N,N′-xylylenebisstearylamide; higher amines such as dodecylamine, tetradecylamine or octadecylamine; fatty ester compounds such as stearylstearic acid, oleylpalmitic acid, glycerin fatty ester, sorbitan fatty ester, propyleneglycol fatty ester, ethyleneglycol fatty ester, and polyoxyethylene fatty ester (for example, EMALLEX series manufactured by Nippon Emulsion Co., Ltd., Riekmar series manufactured by Riken Vitamin Co., Ltd., Poem series manufactured by Riken Vitamin Co., Ltd, and the like); esters of sucrose fatty acids such as sucrose stearic acid and sucrose palmitic acid (e.g., Ryoto Sugar Ester Series manufactured by Mitsubishi Chemical Foods Corporation); synthetic waxes such as polyethylene wax and α-olefin-maleic anhydride copolymer wax (e.g., UNILIN series manufactured by Baker-Petrolite Corporation); dimer acids; dimer diols (such as PRIPOR series manufactured by CRODA); fatty acid inulins such as inulin stearate; fatty acid dextrins such as dextrin palmitate and dextrin myristate (e.g., LEOPAL series manufactured by Chiba Milling Co., Ltd); glyceryl eicosanedioate behenate; eicosane polyglyceryl behenate (Nomcoat series, manufactured by Nisshin OilLiO Group, Ltd.); amide compounds such as N-lauroyl-L-glutamic acid dibutylamide and N-(2-ethylhexanoyl)-L-glutamic acid dibutylamide (manufactured by Ajinomoto Fine-Techno Co., Inc); 1,3: dibenzylidene sorbitols such as 2,4-bis-O-benzylidene-D-glucitol (Gelol D manufactured by New Japan Chemical Co., Ltd); and the low molecular weight oil gelling agents described in Japanese Unexamined Patent Publication No. 2005-126507, Japanese Unexamined Patent Publication No. 2005-255821 and Japanese Unexamined Patent Publication No. 2010-111790.

The gelling agent is preferably a compound having an alkyl chain with 12 or more carbon atoms from the viewpoint of easily forming a card house structure. The alkyl chain in the compound may be branched.

The compound having a linear alkyl group with 12 or more carbon atoms is an aliphatic ketone compound, an aliphatic ester compound, a higher fatty acid, a higher alcohol, a fatty acid amide, or the like, which has a linear alkyl group having 12 or more carbon atoms. However, higher fatty acids, higher alcohols, fatty acid amides and the like have a polar group such as —OH and —COOH at the end of an alkyl chain, and therefore, have low stability in an ink in a sol state, and are more likely to be precipitated and separated into layers. In addition, the gelling agent may elute from the cured film of the inkjet ink. Therefore, the gelling agent is preferably an aliphatic ketone compound or an aliphatic ester compound. That is, the gelling agent is preferably a compound represented by the following general formula (G1) or (G2).

R1-CO—R2 General formula (G1):

R3-COO—R4 General formula (G2):

In general formulae (G1) and (G2), R1 to R4 each independently represent a hydrocarbon group having a linear portion having 12 or more carbon atoms. R1 to R4 may have a branch portion. In the general formula (G1), the hydrocarbon groups represented by R1 and R2 are each independently preferably an aliphatic hydrocarbon group having a linear portion having 12 to 25 carbon atoms. When the number of carbons of the linear portion included in the aliphatic hydrocarbon groups represented by R1 and R2 is less than 12, not only does the gelling agent not function as a gelling agent because it does not have sufficient crystallinity, but also it may be impossible to form a sufficient space for enclosing the photopolymerizable compound in the card house structure. On the other hand, when the number of carbon atoms of the linear portion included in the aliphatic hydrocarbon group is greater than 25, the melting point becomes excessively high, and thus there is a risk that the the gelling agent cannot be dissolved in the inkjet ink unless the ejection temperature of the inkjet ink is increased in some cases.

Examples of the aliphatic ketone compound represented by general formula (G1) include dilignoseryl ketone (C24-C24), dibehenyl ketone (C22-C22, melting point of 88 °C), distearyl ketone (C18-C18, melting point of 84 °C), dieicosyl ketone (C20-C20), dipalmityl ketone (C16-C16, melting point of 80 °C), dimyristyl ketone (C14-C14), dilauryl ketone (C12-C12, melting point of 68 °C), lauryl myristyl ketone (C12-C14), lauryl palmityl ketone (C12-C16), myristyl palmityl ketone (C14-C16), myristyl stearyl ketone (C14-C18), myristyl behenyl ketone (C14-C22), palmityl stearyl ketone (C16-C18), palmityl behenyl ketone (C16-C22), and stearyl behenyl ketone (C18-C22).

Examples of commercially available products of the aliphatic ketone compound represented by general formula (G1) include 18-Pentatriacontanon (manufactured by Alfa Aeser), Hentriacontan-16-on (manufactured by Alfa Aeser), and KAO WAX TI (manufactured by Kao Corporation). The aliphatic ketone compound may be used alone or in combination of two or more types thereof.

In general formula (G2), the hydrocarbon groups represented by R3 and R4 are not particularly limited, and are each independently preferably an aliphatic hydrocarbon group having a linear portion having 12 to 26 carbon atoms. When the number of carbons in the linear portion included in the aliphatic hydrocarbon group represented by R3 and R4 is 12 or more and 26 or less, similarly to the compound represented by general formula (G1), the above-described card house structure can be formed while having the crystallinity required for a gelling agent, and the melting point does not become excessively high.

Examples of the aliphatic ester compound represented by the general formula (G2) include behenyl behenate (C21-C22, melting point of 70 °C), icosyl icosanoate (C19-C20), and stearyl stearate (C17-C18, melting point of 60 °C). Examples of such compounds include palmityl stearate (C17-C16), lauryl stearate (C17-C12), and cetyl palmitate (C15-C16, melting point of 54 °C). Examples of such compounds include stearyl palmitate (C15-C18), myristyl myristate (C13-C14, melting point of 43 °C), cetyl myristate (C13-C16, melting point of 50 °C), and octyldodecyl myristate (C13-C20). In addition, examples of the compound include stearyl oleate (C17-C18), stearyl erucate (C21-C18), stearyl linoleate (C17-C18), behenyl oleate (C18-C22), and myricyl cerotenate (C25-C16). Further, examples of the compound include stearyl montanate (C27-C18), behenyl montanate (C27-C22), arachidyl linoleate (C17-C20), and palmityl triacontanoate (C29-C16).

Examples of commercially available products of the aliphatic ester compound represented by general formula (G2) include Unister M-SS (manufactured by NOF Corporation), Exepearl 2222SL (manufactured by Kao Corporation, melting point of 60 °C), and Emalex CC-18 (manufactured by Nippon Emulsion Co., Ltd). Furthermore, examples of the compound include AMREPS PC (manufactured by Kokyu Alcohol Kogyo Co., Ltd.), EXEPEARL MY-M (manufactured by Kao Corporation), SPERMACETI (manufactured by NOF Corporation), and EMALEX CC-10 (manufactured by Nippon Emulsion Co., Ltd). These commercially available products are often mixtures of two or more types, and therefore, may be separated and purified, when necessary.

The aliphatic ester compound contained in the active ray curable inkjet ink may be used alone or in combination of two or more types thereof.

The content of the gelling agent in the active ray curable inkjet ink is preferably in a range of 0.5 to 7.0% by mass and more preferably in a range of 1.0 to 5.0% by mass based on the total amount of the inkjet ink. When the content of the gelling agent is less than 0.5% by mass, the inkjet ink may be insufficiently gelled (temperature-dependent sol-gel phase transition). On the other hand, when the content of the gelling agent is more than 7.0% by mass, the hardness of the obtained cured film is insufficient, and the image surface may be easily scratched.

### 1-3. Photopolymerization Initiator

The photopolymerization initiator is classified into an intramolecular bond cleavage type and an intramolecular hydrogen abstraction type.

Examples of the intramolecular bond cleavage type photopolymerization initiator include diethoxyacetophenone, 2-hydroxy-2-methyl-1-phenylpropan-1-one, and benzyl dimethyl ketal. Furthermore, examples of the compound include 1-(4-isopropylphenyl)-2-hydroxy-2-methylpropan-1-one and 4-(2-hydroxyethoxy)phenyl-(2-hydroxy-2-propyl) ketone. Furthermore, examples of the compound include acetophenones such as 1-hydroxycyclohexyl-phenyl ketone, 2-methyl-2-morpholino (4-thiomethylphenyl) propan-1-one and 2-benzyl-2-dimethylamino-1-(4-morpholinophenyl)-butanone; benzoins such as benzoin, benzoin methyl ether and benzoin isopropyl ether; acylphosphine oxides such as 2,4,6-trimethylbenzoin diphenylphosphine oxide; and benzyl and methylphenyl glyoxy esters.

Examples of the intramolecular hydrogen abstraction type photopolymerization initiator include benzophenones such as benzophenon, methyl o-benzoylbenzoate-4-phenylbenzophenone, 4,4′-dichlorobenzophenone, hydroxybenzophenone, 4-benzoyl-4′-methyl-diphenyl sulfide, acrylated benzophenones, 3,3′,4,4′-tetra(t-butylperoxycarbonyl)benzophenon, and 3,3′-dimethyl-4-methoxybenzophenone; thioxanthones such as 2-isopropylthioxanthone, 2,4-dimethylthioxanthone, 2,4-diethylthioxanthone, and 2,4-dichlorothioxanthone; aminobenzophenones such as Michler's ketone and 4,4′-diethylaminobenzophenone; and 10-butyl-2-chloroacridone, 2-ethylanthraquinone, 9,10-phenanthrenequinone, and camphorquinone.

As the photopolymerization initiator, from the viewpoint of high photosensitivity, an acylphosphine oxide and an acyl phosphonate are preferable, and to be specific, bis(1,4,6-trimethylbenzoyl)-phenylphosphineoxide and bis(2,6-dimethoxybenzoyl)-2,4,4-trimethyl-pentylphosphineoxide are more preferable.

The content of the photopolymerization initiator is preferably in a range of 0.1 to 10.0% by mass and more preferably in a range of 2 to 8% by mass based on the total amount of the inkjet ink.

The inkjet ink may contain a photoacid generator as a photopolymerization initiator. As an example of the photoacid generator, a compound used for a chemically amplified photoresist or photocationic polymerization is used. The inkjet ink may further contain a photopolymerization initiator auxiliary agent or a polymerization inhibitor, when necessary.

### 1-4. Others

The photopolymerization initiator auxiliary agent may be a tertiary amine compound, and is preferably an aromatic tertiary amine compound. Examples of the aromatic tertiary amine compound include N,N-dimethylaniline, N,N-diethylaniline, N,N-dimethyl-p-toluidine, and N,N-dimethylamino-p-benzoic acid ethyl ester. Examples of such compounds include N,N-dimethylamino-p-benzoic acid isoamylethyl ester, N,N-dihydroxyethylaniline, triethylamine and N,N-dimethylhexylamine. The photopolymerization initiator auxiliary agent is preferably N,N-dimethylamino-p-benzoic acid ethyl ester or N,N-dimethylamino-p-benzoic acid isoamylethyl ester. The photopolymerization initiator auxiliary agents may be used alone or in combination of two or more types thereof.

Examples of the polymerization inhibitor include (alkyl) phenols, hydroquinones, catechol, resorcinol, p-methoxyphenol, t-butylcatechol, t-butylhydroquinone, pyrogallol, 1,1-picrylhydrazyl, and phenothiazine. Examples of such compounds include p-benzoquinone, nitrosobenzene, 2,5-di-tert-butyl-p-benzoquinone, dithiobenzoyl disulfide, picric acid, cupferron, and aluminum N-nitrosophenylhydroxylamine. Examples of such compounds include tri-p-nitrophenylmethyl, N-(3-oxyanilino-1,3-dimethylbutylidene)aniline oxide, dibutyl cresol, cyclohexanone oxime cresol, guaiacol, and o-isopropylphenol. Examples of the compound include butyraldoxime, methyl ethyl ketoxime, and cyclohexanone oxime.

The inkjet ink may further contain a coloring material. The coloring material may be a dye or a pigment, and is preferably a pigment.

Examples of the pigment include C.I. Pigment Yellow 1, 2, 3, 12, 13, 14, 16, 17, 73, 74, 75, 81, 83, 87, 93, 95, 97, 98, 109, 114, 120, 128, 129, 138, 150, 151, 154, 155, 180, 185, 213, C.I. Pigment Red 5, 7, 12, 22, 38, 48:1, 48:2, 48:4, 49:1, 53:1, 57:1, 63:1, 101, 112, 122, 123, 144, 146, 168, 184, 185, 202, C.I. C.I. Pigment Violet 19, 23, C.I. Pigment Blue 1, 2, 3, 15:1, 15:2, 15:3, 15:4, 18, 22, 27, 29, 60, C.I. Pigment Green 7, 36, and C.I. Pigment White 6, 18, 21, C.I. Pigment Black 7.

The average particle diameter of the pigment is preferably in a range of 0.08 to 0.50 μm, and the maximum particle diameter of the pigment is in a range of 0.3 to 10.0 μm, and preferably in a range of 0.3 to 3.0 μm. Adjustment of the particle diameter of the pigment can reduce clogging of nozzles of an inkjet head and maintain the storage stability, transparency, and curing sensitivity of the inkjet ink.

On the other hand, the dye contained in the active ray curable inkjet ink is an oil-soluble dye or the like. The oil-soluble dye includes the following various dyes.

Examples of magenta dyes include MS Magenta VP, MS Magenta HM-1450, MS Magenta HSo-147 (all manufactured by Mitsui Toatsu Co., Ltd.), AIZEN SOT Red-1, AIZEN SOT Red-2, AIZEN SOT Red-3, AIZEN SOT Pink-1, SPIRON Red GEH SPECIAL (all manufactured by Hodogaya Chemical Co., Ltd.), RESOLIN Red FB 200%, MACROLEX Red Violet R, MACROLEX ROT5B (all manufactured by Bayer Japan Ltd.), KAYASET Red B, KAYASET Red 130, KAYASET Red 802 (all manufactured by Nippon Kayaku), PHLOXIN, ROSE BENGAL, ACID Red (all manufactured by Daiwa Kasei), HSR-31, DIARESIN Red K (all manufactured by Mitsubishi Kasei), and Oil Red (manufactured by BASF Japan Ltd.).

Examples of cyan dyes include MS Cyan HM-1238, MS Cyan HSo-16, Cyan HSo-144, and MS Cyan VPG (all manufactured by Mitsui Toatsu Co., Ltd.), AIZEN SOT Blue-4 (manufactured by Hodogaya Chemical Co., Ltd.), RESOLIN BR. Blue BGLN 200%, MACROLEX Blue RR, CERES Blue GN, SIRIUS SUPRATURQ. Blue Z-BGL, and SIRIUS SUPRA TURQ. Blue FB-LL 330% (all manufactured by Bayer Japan Ltd.), KAYASET Blue FR, KAYASET Blue N, KAYASET Blue 814, Turq. Blue GL-5 200, Light Blue BGL-5 200 (all manufactured by Nippon Kayaku Co., Ltd.), DAIWA Blue 7000, Oleosol Fast Blue GL (all manufactured by Daiwa Kasei Co., Ltd.), DIARESIN Blue P (manufactured by Mitsubishi Kasei Corporation), and SUDAN Blue 670, NEOPEN Blue 808, ZAPON Blue 806 (all manufactured by BASF Japan Ltd.).

Examples of yellow dyes include MS Yellow HSm-41, Yellow KX-7, Yellow EX-27 (Mitsui Toatsu), AIZEN SOT Yellow-1, AIZEN SOT Yellow W-3, AIZEN SOT Yellow-6 (all manufactured by Hodogaya Chemical Co., Ltd.), MACROLEX Yellow 6G, MACROLEX FLUOR. Yellow 10GN (all manufactured by Bayer Japan), KAYASET Yellow SF-G, KAYASET Yellow 2G, KAYASET Yellow A-G, KAYASET Yellow E-G (all manufactured by Nippon Kayaku Co., Ltd.), DAIWA Yellow 330HB (manufactured by Daiwa Kasei Co., Ltd.), HSY-68 (manufactured by Mitsubishi Kasei Corporation), and SUDAN Yellow 146, NEOPEN Yellow 075 (all manufactured by BASF Japan Ltd.).

Examples of the black dye include MS Black VPC (manufactured by Mitsui Toatsu Co., Ltd), AIZEN SOT Black-1, AIZEN SOT Black-5 (manufactured by Hodogaya Chemical Co., Ltd), RESORIN Black GSN 200%, RESOLIN BlackBS (manufactured by Bayer Japan Ltd), KAYASET Black A-N (manufactured by Nippon Kayaku Co., Ltd), DAIWA Black MSC (manufactured by Daiwa Kasei Co., Ltd), HSB-202 (manufactured by Mitsubishi Kasei Corporation), NEPTUNE Black X60, and NEOPEN Black X58 (manufactured by BASF Japan Ltd).

The content of the coloring material is preferably in a range of 0.1 to 20.0% by mass, and more preferably in a range of 0.4 to 10.0% by mass. When the content of the coloring material is excessively small, the color development of the obtained image is not sufficient, and when the content is excessively large, the viscosity of the inkjet ink increases, and the ejection stability is more likely to deteriorate.

The inkjet ink may further contain, as a dispersion aid, a synergist each corresponding to various pigments. The total amount of the dispersant and the dispersion aid is preferably in the range of 1 to 50% by mass relative to the pigment.

From the viewpoint of facilitating dispersion of the pigment, the inkjet ink is preferably obtained by mixing a pigment dispersion liquid with other ink components.

The pigment dispersion liquid can be obtained by dispersing a pigment in a dispersion medium. The pigment may be dispersed using, for example, a ball mill, a sand mill, an attritor, a roll mill, an agitator, a Henschel mixer, a colloid mill, an ultrasonic homogenizer, a pearl mill, a wet jet mill, or a paint shaker. In addition, a dispersant may be added when the pigment is dispersed. The dispersant is preferably a polymer dispersant, and the polymer dispersant may be Solsperse series manufactured by Avecia Inc., PB series manufactured by Ajinomoto Fine-Techno Co., Inc., or the like. The dispersion medium of the pigment dispersion liquid is a solvent or a photopolymerizable compound. It is preferable that the pigment dispersion liquid does not contain a solvent in order that gelation is easily caused immediately after landing on a recording medium, or in order that a reduction in solvent resistance of a cured product is suppressed and a problem of volatile organic compounds of a residual solvent is suppressed. Therefore, the dispersion medium of the pigment dispersion liquid is preferably a photopolymerizable compound, particularly a monomer having a low viscosity, from the viewpoint of dispersibility.

The inkjet ink may further contain other components, when necessary. Examples of the other components include additives and other resins. Examples of the additive include surfactants, leveling additives, matting agents, UV absorbers, infrared rays absorbers, antibacterial agents, and basic compounds for enhancing the storage stability of the ink. Examples of the basic compound include basic alkali metal compounds, basic alkaline earth metal compounds, and basic organic compounds such as amines. Examples of the other resin include resins for adjusting physical properties of a cured film, and examples thereof include polyester-based resins, polyurethane-based resins, vinyl-based resins, acrylic-based resins, rubber-based resins, and waxes.

### 1-5. Physical Properties

Since the inkjet ink contains a gelling agent, it undergoes a reversible sol-gel phase transition depending on a temperature. An inkjet ink that undergoes a sol-gel phase transition is liquid (sol) at high temperature (e.g., about 80 °C), and thus can be ejected from an inkjet head. Droplets of the inkjet ink ejected at a high temperature lands on a recording medium and are then naturally cooled to gel. Thus, coalescence of adjacent dots can be suppressed and image quality can be improved.

From the viewpoint of enhancing ejection stability of the inkjet ink, the viscosity of the inkjet ink under a high temperature is preferably equal to or less than a certain level. To be specific, the viscosity of the inkjet ink at 80 °C is preferably in a range of 3 to 20 mPa·s. On the other hand, from the viewpoint of suppressing the coalescence of adjacent dots, the viscosity of the inkjet ink under normal temperature after landing is preferably a certain level or more. To be specific, the viscosity of the inkjet ink at 25 °C is preferably 1000 mPa·s or more.

The gelation temperature of the inkjet ink is preferably in a range of 40 °C or more and 70 °C or less, more preferably in a range of 50 °C or more and 65 °C or less. In the case where the ejection temperature is around 80 °C, when the gelation temperature of the inkjet ink exceeds 70 °C, gelation is more likely to occur at the time of ejection, and thus the ejection stability is more likely to deteriorate. On the other hand, in the case where the gelation temperature is lower than 40 °C, the inkjet ink after landing on a recording medium is less likely to rapidly gel. The gelation temperature is a temperature at which the inkjet ink in a sol state is gelled and the fluidity decreases in the process of cooling the inkjet ink.

The viscosity of the inkjet ink at 80 °C, the viscosity at 25 °C, and the gelation temperature of the inkjet ink can be determined by measuring a temperature change in the dynamic viscoelasticity of the inkjet ink with a rheometer. Specifically, a temperature change curve of the viscosity is obtained when the inkjet ink is heated to 100 °C and cooled to 20 °C under conditions of a shear rate of 11.7 (1/s) and a temperature lowering rate of 0.1 °C/s. The viscosity at 80 °C and the viscosity at 25 °C can be obtained by reading the viscosities at 80 °C and 25 °C, respectively, in the viscosity-temperature change curve. The gelation temperature can be determined as a temperature at which the viscosity becomes 200 mPa·s in the temperature change curve of viscosity.

The rheometer that can be used is the stress-controlled rheometer Physica MCR series manufactured by Anton Paar. The cone plate may have a diameter of 75 mm and a cone angle of 1.0°.

The inkjet ink can be obtained by preparing a pigment dispersion solution in which a coloring material (particularly, a pigment) is dispersed in a part of a photopolymerizable compound, and mixing the pigment dispersion solution, the photopolymerizable compound, a photopolymerization initiator, a gelling agent, and the like.

### 2. Image Forming Method

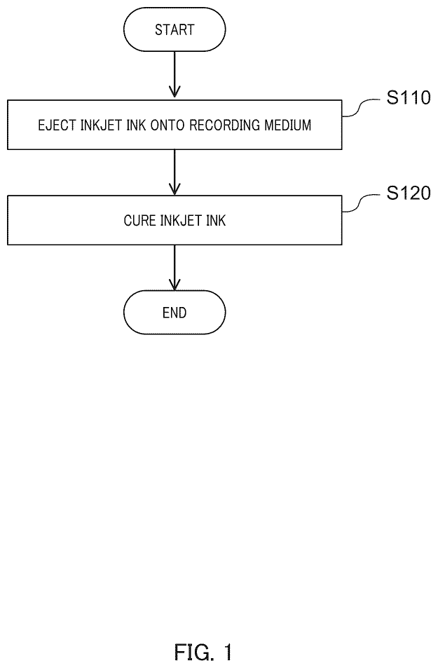

FIG. 1 is a flowchart of an image forming method according to an embodiment of the present invention. The image forming method according to the present embodiment includes, as illustrated in FIG. 1, a step of ejecting an inkjet ink onto a recording medium (S110) and a step of curing the inkjet ink (S120). The image forming method of the present invention can be performed, for example, by an image forming apparatus described below. In the image forming apparatus, an inkjet ink is ejected by an inkjet head to a recording medium conveyed from an upstream side to a downstream side, and then the inkjet ink is cured by irradiation with active rays.

2-1. Step of Ejecting Inkjet Ink onto Recording Medium (S110)

In the step (S110) of ejecting an inkjet ink onto a recording medium, an inkjet ink is ejected onto a recording medium from an inkjet head of an inkjet apparatus. The temperature of the inkjet ink in the inkjet head is preferably set to a temperature higher by 10 to 30 °C than the gelation temperature of the inkjet ink, from the viewpoint of enhancing the ejection stability of the inkjet ink.

When the temperature of the inkjet ink in the inkjet head is lower than a temperature that is higher than the gelation temperature by 10 °C, the inkjet ink gels in the inkjet head or on the nozzle surface, and the ejection stability of the inkjet ink tends to decrease. On the other hand, when the temperature of the inkjet ink in the inkjet head exceeds a temperature that is higher than the gelation temperature by 30 °C, the temperature of the inkjet ink becomes too high, and thus the components of the inkjet ink may deteriorate.

The amount of one droplet ejected from each nozzle of the inkjet head is preferably in a range of 0.5 to 10.0 pL, and more preferably in a range of 0.5 to 2.5 μL for forming a high-definition image, although it depends on the definition of the image.

The ink droplets applied to the recording medium are cooled and rapidly gelate by a sol-gel phase transition. Thus, the ink droplets can be pinned without being diffused. In addition, since oxygen is less likely to diffuse into the gelled inkjet ink, oxygen inhibition to the photopolymerizable compound can be reduced.

The recording medium may be paper or a resin film. Examples of the paper include coated paper for printing, art paper for printing, high-quality paper, and plain paper. Examples of the resin film include polyethylene terephthalate films and vinyl chloride films. The temperature of the recording medium when the inkjet ink lands is preferably set to a temperature lower by 10 to 20 °C than the gelation temperature of the inkjet ink. When the temperature of the recording medium is too low, the inkjet ink may gel before sufficient leveling, resulting in a decrease in image gloss. On the other hand, when the temperature of the recording medium is excessively high, the inkjet ink is less likely to be gelled, and adjacent dots are more likely to be mixed (less likely to be pinned). Appropriate leveling to the extent that adjacent dots are not mixed with each other and appropriate pinning are realized by appropriately adjusting the temperature of the recording medium. The temperature of the recording medium can be adjusted by a temperature control means (i.e., temperature controller) of the image forming apparatus to be described below.

The speed at which the recording medium is conveyed from upstream to downstream is preferably 50 m/min or more, and more preferably 60 m/min or more. The conveyance speed of the recording media is preferably 120 m/min or less. When the conveyance speed of the recording medium is less than 50 m/min, the inkjet recording speed decreases. On the other hand, when the conveyance speed of the recording media exceeds 120 m/min, the curing of the inkjet ink may become insufficient.

### 2-2. Step of Curing Inkjet Ink (S120)

In step (S120) of curing an inkjet ink, the inkjet ink landed on a recording medium is irradiated with active rays to cure a photopolymerizable compound contained in the inkjet ink. The irradiation with active rays can be performed by an image forming apparatus to be described below. The irradiation with active rays is preferably performed after ink droplets have been ejected from all the inkjet heads. In order to inhibit adjacent ink droplets from coalescing, the irradiation with active rays is preferably performed within 10 seconds, preferably within 0.001 to 5.000 seconds, and more preferably within 0.01 to 2.00 seconds after the ink droplets have landed on the recording medium.

In step (S120) of curing an inkjet ink, when an active ray irradiation region in an image forming apparatus is divided into two in the central portion of the active ray irradiation region in the conveyance direction of a recording medium, active rays are applied in such a way that an integrated amount of the active rays in a downstream portion of the active ray irradiation region is greater than an integrated amount of the active rays in an upstream portion of the active ray irradiation region. The active ray irradiation region means, in the image forming apparatus, a range irradiated with active rays from an active ray irradiation section (i.e., active ray irradiator).

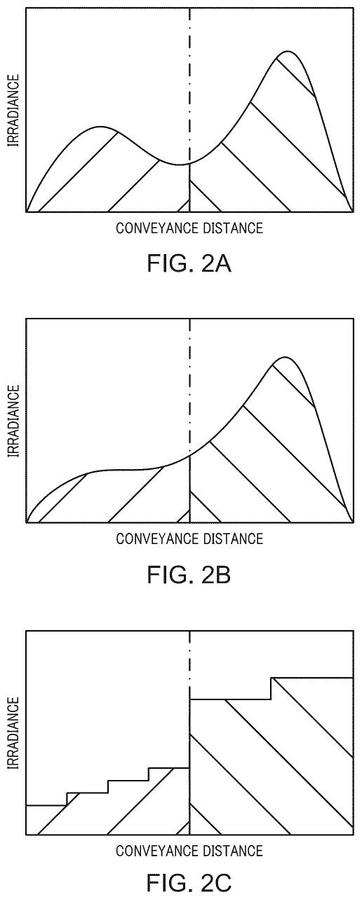

FIGS. 2A to 2C are schematic irradiance distributions for explaining an example of the integrated light amount. The horizontal axes of FIGS. 2A to 2C indicate conveyance distance of a recording media from the upstream end portion of the active ray irradiation region, and the vertical axes indicate irradiance. The one dot chain line in FIGS. 2A to 2C indicates the center position when the active ray irradiation region is divided into two equal parts in the conveyance direction of the recording sheet. The left half in FIGS. 2A to 2C indicates the upstream side, and the right half indicates the downstream side.

As illustrated in FIG. 2A, the irradiance distribution may be a smooth bimodal distribution having one peak in the upstream portion and one peak in the downstream portion. Furthermore, as illustrated in FIG. 2B, the irradiance distribution may be a distribution having a peak only in the downstream portion. Alternatively, as illustrated in FIG. 2C, the distribution may be such that the irradiance changes stepwise. Here, the integrated light amount can be calculated by multiplying the irradiance by the irradiation time of the active rays. In the present embodiment, since the conveyance speed of the recording medium is constant, a value obtained by multiplying the irradiance by the conveyance distance can be treated as a value corresponding to the integrated light amount. That is, in FIGS. 2A to 2C, by comparing the area of the shaded portion in the left half with the area of the shaded part in the right half, it is possible to compare the integrated light amount on the upstream side and the integrated light amount on the downstream side. In the present embodiment, the area of the shaded portion in the right half (downstream side) is larger than the area of the shaded portion in the left half (upstream side).

It is preferable to perform irradiation with active rays in such a way that the ratio of the integrated amount of active rays in the upstream portion to the integrated amount of active rays in the downstream portion is 20:80 to 40:60.

The maximum irradiance of the active rays in the upstream portion is preferably in the range of 0.01 W/cm² or more and less than 1.5 W/cm², and the maximum irradiance of the active rays in the downstream portion is preferably in the range of 4 W/cm² or more and less than 8 W/cm². When the maximum irradiance of the active rays in the upstream portion is less than 0.01 W/cm², the inkjet ink may become insufficiently cured. On the other hand, when the maximum irradiance of the active rays in the upstream portion is the 1.5 W/cm² or more, the inkjet ink may melt. When the maximum irradiance of the active rays in the downstream portion is less than 4 W/cm², a sufficient integrated light amount cannot be obtained, and the adhesiveness to recording media may be deteriorated. On the other hand, when the maximum irradiance of the active rays in the downstream portion is 8 W/cm² or more, the curability becomes too high, and warping may occur depending on the type of recording media.

In the step of curing the inkjet ink, the total value of the integrated light amount of the active rays to be applied in the active ray irradiation region is preferably in a range of 200 mJ/cm² or more and less than 500 mJ/cm². Here, the total value of the integrated light amount means the integrated light amount of the active rays to be applied from the upstream end to the downstream end of the active ray irradiation region. Note that in FIGS. 2A to 2C, the total value of the integrated light amounts is the sum of the area of the left half shaded portion and the area of the right half shaded portion. When the integrated light amount is less than 200 mJ/cm², the inkjet ink might not be completely cured. On the other hand, when the integrated light amount is greater than or equal to the 500 mJ/cm², gelled inkjet ink on the recording medium may be melted by heat.

A method of adjusting the integrated light amount with respect to the recording medium is not particularly limited. Here, a case where the recording medium is conveyed at a constant speed will be described. Examples of the method for adjusting the integrated light amount include a method in which the distance between the recording medium and the light source is adjusted on the upstream side and the downstream side in the active ray irradiation region. Specifically, the light source is disposed in such a way that the distance between the recording medium and the light source becomes long on the upstream side in the active ray irradiation region, and the light source is disposed in such a way that the distance between the recording medium and the light source becomes short on the downstream side in the active ray irradiation region. Further, examples of the method for adjusting the integrated light amount include a method of adjusting the density of light sources to be disposed on the upstream side and the downstream side in the active ray irradiation region. Note that in this case, the distance between the recording medium and the light source is the same on the upstream side and the downstream side in the active ray irradiation region. Specifically, the light sources are disposed in such a way that the density thereof is low on the upstream side in the active ray irradiation region, and the light sources are disposed in such a way that the density thereof is high on the downstream side in the active ray irradiation region.

Here, a mechanism by which the image forming method of the present embodiment can appropriately cure the active ray curable inkjet ink regardless of the conveyance speed of the recording medium will be described. The gelling agent of the inkjet ink ejected from the inkjet head and landed on the recording medium is precipitated after landing. The precipitated gelling agent in the inkjet ink is irradiated with active rays having a low integrated light amount. Accordingly, melting of the ink coating film due to an excessive increase in the temperature of the surface of the recording medium is suppressed, and the gelling agent is non-uniformly dispersed in the ink coating film (a three dimensional network structure is formed). Next, the inkjet ink is irradiated with active rays having a high integrated light amount. Thus, the gelling agent in the ink coating film is uniformly fixed in the meshes of the ink coating film. In the image thus formed, the gelling agent also functions as a filler. Therefore, it is presumed that in the cured inkjet ink (image), the gelling agent is uniformly disposed, so that the force to be applied in the cutting process is leveled (dispersed), thus the cutting processability becomes satisfactory. Note that the image forming method according to the present embodiment is particularly effective in the case of printing a thick film on a recording medium having high permeability, such as high-quality paper.

### 3. Image Forming Apparatus

The image forming apparatus used in the image forming method of the present embodiment may be a line recording system (single pass recording system) or a serial recording system. The image forming apparatus is preferably a line recording-type image forming apparatus from the viewpoint of increasing the recording speed.

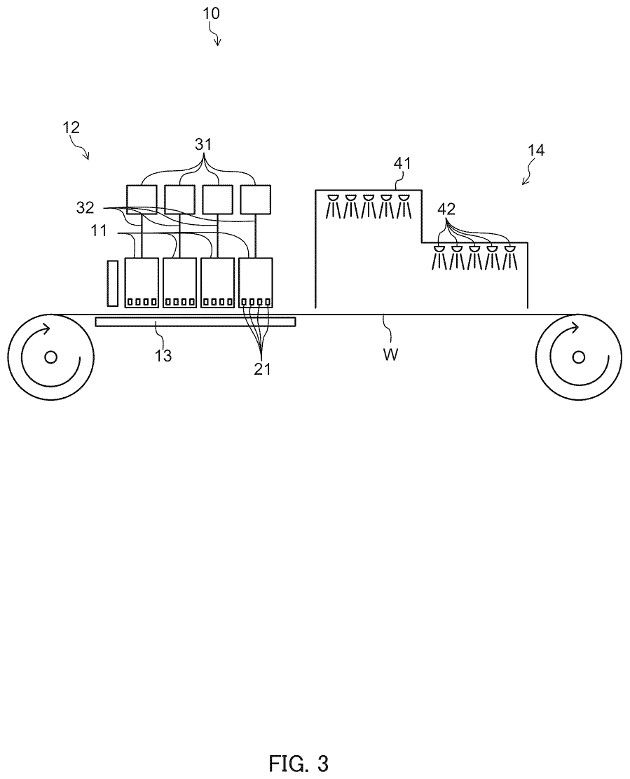

FIG. 3 is a schematic diagram illustrating a configuration of the image forming apparatus.

As illustrated in FIG. 3, the image forming apparatus 10 includes a head carriage 11 for housing a plurality of inkjet heads 21, an ink supply section (i.e., ink supplier) 12 for supplying inkjet ink to the head carriage 11, a temperature control means 13 disposed below the lower surface of the recording medium W, and an active ray irradiation section 14 disposed on the downstream side of the head carriage 11 (in the conveyance direction of the recording medium).

The head carriage 11 is disposed so as to cover the entire width of the recording medium W, and houses a plurality of inkjet heads 21 provided for each color. The number of head carriages 11 is not particularly limited. In the present embodiment, the number of head carriages 11 is the same as the number of colors of inkjet ink.

The inkjet head 21 ejects the inkjet ink supplied from the ink supply section 12 onto the recording medium W. A plurality of inkjet heads 21 are disposed in the conveyance direction of the recording medium W for each color.

The number of inkjet heads 21 disposed in the conveyance direction of the recording medium W is set according to the nozzle density of the inkjet heads 21 and the resolution of the printed image. For example, in the case where an image having a resolution of 1440 dpi is formed using the inkjet heads 21 having a droplet amount of 2 μL and a nozzle density of 360 dpi, the four inkjet heads 21 may be disposed so as to be shifted with respect to the conveyance direction of the recording medium W. In addition, in the case where an image having 720×720 dpi resolution is formed using the inkjet heads 21 having a droplet amount of 6 μL and a nozzle density of 360 dpi, the two inkjet heads 21 may be disposed to be shifted from each other. Here, dpi represents the number of ink droplets (dots) per 2.54 cm.

The ink supply section 12 supplies inkjet ink to the inkjet head 21. The ink supply section 12 includes a tank 31 in which inkjet ink is stored, and an ink channel 32 connecting the tank 31 and the inkjet head 21.

The tank 31 is connected to the head carriage 11 via an ink channel 32. From the viewpoint of stably ejecting ink droplets, a heating mechanism (not illustrated) is disposed to heat the ink in the tank 31, the ink channel 32, the head carriage 11, and the inkjet head 21 to a predetermined temperature.

The active ray irradiation section 14 irradiates the recording medium W, on which the inkjet ink ejected from the inkjet head 21 has landed, with active rays. The active ray irradiation section 14 is disposed on the downstream side in the conveyance direction of the recording medium W. The active ray irradiation section 14 includes a housing 41 for partitioning an active ray irradiation region, and a light source 42 for emitting active rays.

The housing 41 is disposed so as to cover the light sources 42 and is disposed in such a way that the active rays do not leak out from the active ray irradiation region. The housing 41 is made of, for example, aluminum, and is designed so that active rays emitted from the light source 42 are reflected toward the recording medium W by the inner surface of the housing.

The light source 42 emits active rays toward the recording medium W. The number of light sources 42 is not particularly limited as long as it is two or more. In the present embodiment, a plurality of the light sources are disposed on each of the upstream side and the downstream side in the active ray irradiation region. The type of active rays to be emitted from the light source 42 is appropriately set according to the type of inkjet ink. The type of the active rays is, for example, ultraviolet rays. The peak wavelengths of the active rays emitted by the light sources 42 are, for example, preferably in the range of 360 to 420 nm, and more preferably in the range of 380 to 410 nm. The light source 42 is not particularly limited, but is preferably a surface-emitting type LED, more preferably a surface-emitting type UV-LED. The surface-emitting type UV-LED includes a substrate and a plurality of light emitting elements disposed thereon, and may further include, when necessary, a lens or a diffusion plate in front of the light emitting elements in order to adjust light collection and light diffusion.

The temperature control means 13 is disposed below the lower surface of the recording medium W and maintains the temperature of the recording medium W at a predetermined temperature. The temperature control means 13 is, for example, any one of various heaters.

### Effect

As described above, in the present invention, irradiation with active rays is performed in such a way that the integrated amount of active rays in the downstream portion is larger than the integrated amount of active rays in the upstream portion, and therefore the cutting processability of the formed image is satisfactory regardless of the conveyance speed of the recording medium W.

### Second Disclosure

### 1. Inkjet Ink

An inkjet ink curable by active rays (hereinafter, referred to as active ray curable inkjet ink) according to the present disclosure includes a polymerizable compound polymerizable by active rays (hereinafter, referred to as active ray polymerizable compound). In addition, when the weighted average value (based on mass) of the number of ethylene oxide groups per molecule in the active ray polymerizable compound is X and the weighted average value (based on mass) of the number of propylene oxide groups per molecule in the active ray polymerizable compound is Y, X+Y is 3 or more and 9 or less. In addition, the content of a polymerizable compound having a melting point of 25 °C or higher is less than 3% by mass based on the total mass of the active ray polymerizable compounds.

The active ray polymerizable compound in the present disclosure correspond to the photopolymerizable compound in the first disclosure. Therefore, the photopolymerizable compound in the first disclosure can be naturally replaced with the active ray polymerizable compound in the present disclosure.

Recording media on which images have been formed with conventional active ray curable inkjet ink, for example, as disclosed in Japanese Unexamined Patent Publication No. 2016-172841 are sometimes bent during transport or storage. At this time, cracking may occur in the formed image. Therefore, it is desirable that the inkjet ink can form an image that is less likely to have cracks (cracking by folding) when the recording medium is folded.

In addition, in order to suppress peeling of the formed image from the recording medium, the active ray curable inkjet ink may be required to form an image having enhanced abrasion resistance (scratch resistance) and internal curability (adhesion to a substrate).

The present disclosure has been made in consideration of the above-described circumstances, and an object of the second disclosure is to provide an image forming apparatus capable of forming an image which is less prone to cracking by folding and has high abrasion resistance and high internal curability. Another object of the present disclosure is to provide an image forming method using the image forming apparatus.

The present inventors have found that when an active ray polymerizable compound contained in the ink satisfies the numerical value of X+Y, cracking of an image when a recording medium is folded (hereinafter, referred to as cracking by folding or folding crack) can be made less likely to occur, and an image having high abrasion resistance and high internal curability can be formed. It is necessary to increase the flexibility of the image in order that the folding crack of the image is less likely to occur, and it is necessary to increase the hardness of the image in order that the abrasion resistance and the internal curability are increased. Therefore, it may be difficult to achieve both of these properties.

However, according to the active ray curable inkjet ink of the present disclosure, both of these properties can be achieved.

That is, when the above X+Y is 3 or more, the amount of ethylene oxide groups (hereinafter referred to as EO groups) and propylene oxide groups (hereinafter referred to as PO groups) contained in the polymer chains of the active ray polymerizable compound increases. Since EO groups and PO groups increase the molecular mobility, when X+Y is 3 or more, the flexibility of the cured film (image) is sufficiently increased, and the image easily follows the recording medium when the recording medium is folded. As a result, it is possible to make it difficult for cracking by folding to occur in the image.

On the other hand, when X+Y is excessively increased to excessively increase the flexibility of the image, the hardness of the cured film decreases, resulting in a decrease in the abrasion resistance of the image. Therefore, when X+Y is 9 or less, the hardness of the cured film can be less likely to be reduced without excessively increasing the flexibility of the cured film. Therefore, by setting X+Y to 9 or less, the flexibility of the cured film is not increased too much, and the hardness of the cured film is not easily reduced.

In addition, when X+Y is 9 or less, excessive increase in the viscosity of the ink, which is caused by excessive formation of hydrogen bonds between molecules of the active ray polymerizable compound to reduce the mobility of the molecules, can be suppressed. Thus, the ejection stability can be enhanced.

Furthermore, when the content of a polymerizable compound having a melting point of 25 °C or higher is lower than 3% by mass based on the total mass of the active ray polymerizable compounds, the ejection stability can also be enhanced. The polymerizable compound having a melting point of 25 °C or higher tends to increase the viscosity of the ink at room temperature or at a temperature at which the ink is heated at the time of ink ejection. In contrast, when the content is less than 3% by mass, the ejection stability can be enhanced.

Furthermore, the image forming apparatus according to the present embodiment includes a preliminary irradiation section (i.e., preliminary irradiation section) and a main irradiation section (i.e., main irradiation section) for irradiation with active rays. Thus, the active ray curable inkjet ink applied to the recording medium is preliminarily cured by the preliminary irradiation section and then fully cured by the main irradiation section, so that the image is less likely to be cracked by folding and the rub fastness and the internal curability of the image are enhanced.

In the present specification, the weighted average value X of the number of EO groups per molecule refers to a value obtained by summing values calculated for all the polymerizable compounds contained in the active ray polymerizable compound—each of the values is calculated by multiplying the number of EO groups in one molecule of each polymerizable compound by the mass ratio of the polymerizable compound in the active ray polymerizable compound. Similarly, the weighted average value Y of the number of PO groups per molecule refers to a value obtained by summing values calculated for all the polymerizable compounds contained in the active ray polymerizable compound—each of the values is calculated by multiplying the number of PO groups in one molecule of each polymerizable compound by the mass ratio of the polymerizable compound in the active ray polymerizable compound.

Hereinafter, the active ray curable inkjet ink of the present disclosure based on the above findings will be described in more detail.

### 1-1. Active Ray Polymerizable Compound

The active ray polymerizable compound is a compound which is polymerized and crosslinked by irradiation with active rays. Examples of the active rays include electron beams, ultraviolet rays, x-rays, y-rays, and X-rays. Among these, ultraviolet rays and electron beams are preferable, and ultraviolet rays are more preferable.

As described above, when the weighted average value (based on mass) of the number of EO groups per molecule in the active ray polymerizable compound is represented by X and the weighted average value (based on mass) of the number of PO groups per molecule in the polymerizable compound is represented by Y, X+Y is 3 or more and 9 or less.

X+Y is preferably 3.5 or more and 8 or less, more preferably 3.5 or more and 7 or less, more preferably 3.5 or more and 6 or less, and more preferably 3.5 or more and 5.5 or less. When X+Y is equal to or greater than 3.5, it is possible to further increase the flexibility of the cured film and to further prevent the folding crack of the image from occurring. In addition, when X+Y is 8 or less, the hardness of the cured film is less likely to be decreased, and thus it is possible to increase the abrasion resistance of the image. Furthermore, when X+Y is 8 or less, the ink viscosity is less likely to increase.

In the above X+Y, X is preferably 1.5 or more and 7 or less, more preferably 1.5 or more and 6 or less. Since an EO group has higher molecular mobility than a PO group, a larger number of EO groups can further increase the flexibility of the cured film. Therefore, when X is 1.5 or more, the folding crack of the image can be more less likely to occur. In addition, when X is 7 or less, the hardness of the cured film is less likely to decrease, and thus the abrasion resistance of the image is further enhanced.

The weighted average value (based on mass) of the repeating number of EO groups and the repeating number of PO groups per molecule in the active ray polymerizable compound are preferably 2 or more and 10 or less, more preferably 2 or more and 8 or less.

In the present specification, the repeating number of EO groups or PO groups per molecule refers to the number of consecutive EO groups or PO groups in a molecular chain. When a plurality of units in which EO groups or PO groups are continuous are contained in one molecule, the repeating number is a value obtained by dividing the total number of continuous EO groups or PO groups by the number of the units. In addition, the weighted average value of the repeating number refers to a value obtained by summing values calculated for all the polymerizable compounds contained in the active ray polymerizable compound—each of the values is calculated by multiplying the repeating number per molecule of each polymerizable compound by the mass ratio of the polymerizable compound in the active ray polymerizable compound.

When the weighted average value of the repeating number is 2 or more, EO groups or PO groups are continuous in the polymer chain, so that a portion having high molecular mobility can be extended, and the flexibility of the cured product can be further enhanced. Thus, the cracking by folding of the image can be further suppressed. In addition, when the weighted average value of the repeating number is 10 or less, the hardness of the cured film is less likely to decrease, and thus the abrasion resistance of the image is further enhanced.

In the present disclosure, the active ray polymerizable compound includes an active ray polymerizable compound having an EO group or an active ray polymerizable compound having a PO group. Examples of the active ray polymerizable compound having an EO group and the active ray polymerizable compound having a PO group include radically polymerizable compounds and cationically polymerizable compounds. Among these, radically polymerizable compounds are preferable. The radically polymerizable compound is a compound having a radically polymerizable ethylenically unsaturated bond. Only one radically polymerizable compound may be contained in the ink singly, or two or more radically polymerizable compounds may be contained in combination.

Examples of the radically polymerizable compound include unsaturated carboxylic acid esters and (meth)acrylates. Of these, (meth)acrylates are preferred. In the present specification, “(meth)acrylate” means acrylate or methacrylate, and “(meth)acrylic” means acrylic or methacrylic.

Examples of the (meth)acrylate having an EO group include the following: polyethylene glycol diacrylate, EO modified products of 1,6-hexanediol di(meth)acrylate, and EO modified products of pentaerythritol tetraacrylate; EO modified products of dipentaerythritol pentaacrylate and EO modified products of dipentaerythritol hexaacrylate; EO-modified products of trimethylolpropane tri(meth)acrylate and EO-modified products of phenol acrylate; and EO-modified products of nonylphenol (meth)acrylate, EO-modified products of cresol (meth)acrylate, and EO-modified products of bisphenol A diacrylate.

Examples of the (meth)acrylate having a PO group include the following: tripropylene glycol diacrylate, PO modification products of neopentyl glycol diacrylate, and PO modification products of trimethylolpropane triacrylate; and PO modification products of glyceryl triacrylate, PO modification products of bisphenol A diacrylate, PO modification products of nonylphenol acrylate, and the like.

The active ray polymerizable compound may include a cationically polymerizable compound having an EO group and a cationically polymerizable compound having a PO group.

The content of the active ray polymerizable compound having an EO group and the active ray polymerizable compound having a PO group is preferably 65% by mass or more based on the total mass of the active ray polymerizable compounds. The upper limit of the content is not particularly limited, and is, for example, 100% by mass.

In the present disclosure, the active ray polymerizable compound may include a polymerizable compound that does not include an EO group or a PO group as long as the value of X+Y satisfies the above-described condition.

Examples of the polymerizable compound containing neither an EO group nor a PO group include radically polymerizable compounds and cationically polymerizable compounds. Among these, radically polymerizable compounds are preferable.

Examples of the radically polymerizable compound include unsaturated carboxylic acid esters and (meth)acrylates. Of these, (meth)acrylates are preferred. The (meth)acrylate may be monofunctional or polyfunctional. Note that in the present specification, the term “(meth)acrylate” is a generic name for “acrylate” and “methacrylate” and means one or both of them. The term “(meth)acryloyl group” is a generic term for “acryloyl group” and “methacryloyl group”, and means one or both of them.

Examples of the monofunctional (meth)acrylate include the following: isoamyl acrylate, stearyl acrylate, lauryl acrylate, octyl acrylate, decyl acrylate, and isomyristyl acrylate; isostearyl acrylate, 2-ethylhexyl-diglycol acrylate, butoxyethyl acrylate, and phenoxyethyl acrylate; cumylphenoxy ethyl acrylate, tetrahydrofurfuryl acrylate, isobornyl acrylate, and 2-hydroxyethyl acrylate; and 2-hydroxypropyl acrylate, 2-hydroxybutyl acrylate, t-butylcyclohexyl acrylate, and the like.

Examples of the bifunctional (meth)acrylate include the following: 1,4-butanediol di(meth)acrylate, 1,6-hexanediol di(meth)acrylate, and 1,9-nonanediol di(meth)acrylate; and neopentyl glycol di(meth)acrylate, hydroxypivalic acid neopentyl glycol di(meth)acrylate, polytetramethylene glycol di(meth)acrylate, and the like.

Examples of the tri- or higher functional (meth)acrylate include the following: trimethylolpropane tri(meth)acrylate, pentaerythritol tri(meth)acrylate, pentaerythritol tetra(meth)acrylate, dipentaerythritol hexa(meth)acrylate, and the like.

Examples of the cationically polymerizable compound include epoxy compounds and vinyl ether compounds.

Examples of the epoxy compound include the following: 3,4-epoxycyclohexylmethyl-3,4′-epoxycyclohexanecarboxylate, nd bis(3,4-epoxycyclohexylmethyl) adipate; ε-caprolactone-modified 3,4-epoxycyclohexylmethyl 3′,4′-epoxycyclohexanecarboxylate and 1-methyl-4-(2-methyloxiranyl)-7-oxabicyclo[4,1,0] heptane; 2-(3,4-epoxycyclohexyl-5,5-spiro-3,4-epoxy) cyclohexanone-meta-dioxane, and bis(2,3-epoxycyclopentyl) ether; diglycidyl ethers of 1,4-butanediol, diglycidyl ethers of 1,6-hexanediol, triglycidyl ethers of glycerin, and the like.

Examples of the vinyl ether compound include the following: ethyl vinyl ether, n-butyl vinyl ether, isobutyl vinyl ether, octadecyl vinyl ether, and cyclohexyl vinyl ether; hydroxybutyl vinyl ether, 2-ethylhexyl vinyl ether, cyclohexanedimethanol monovinyl ether, N-propyl vinyl ether, and isopropyl vinyl ether; monovinyl ether compounds including isopropenyl ether-o-propylene carbonate, dodecyl vinyl ether, diethylene glycol monovinyl ether, octadecyl vinyl ether, and the like, as well as ethylene glycol divinyl ether, diethylene glycol divinyl ether, and triethylene glycol divinyl ether; propylene glycol divinyl ether, dipropylene glycol divinyl ether, and butanediol divinyl ether; and di- or trivinyl ether compounds including hexanediol divinyl ether, cyclohexanedimethanol divinyl ether, and trimethylolpropane trivinyl ether.

The weighted average value (based on mass) of the equivalents of polymerizable groups in the active ray polymerizable compound is preferably 130 g/eq or more and 300 g/eq or less, 150 g/eq or more and 250 g/eq or less, 140 g/eq or more and 300 g/eq or less. The weighted average value (based on mass) of the equivalents of the polymerizable groups in the active ray polymerizable compound is preferably 160 g/eq or more and 300 g/eq or less, more preferably 180 g/eq or more and 300 g/eq or less, and still more preferably 200 g/eq or more and 300 g/eq or less. When the weighted average value is 130 g/eq or more, the degree of crosslinking of the polymer of the active ray polymerizable compound can be appropriately decreased, and the flexibility of the cured film can be further increased. Thus, the cracking by folding of the image can be further suppressed. When the weighted average value is 300 g/eq or less, the degree of curing of the cured film can be further increased without excessively decreasing the degree of crosslinking of the polymer, and thus peeling of the image can be further suppressed.

Note that when the active ray curable inkjet ink contains a yellow pigment as the coloring agent, the weighted average value (based on mass) of the equivalents of the polymerizable groups is preferably 160 g/eq or more and 200 g/eq or less. Furthermore, when the active ray curable inkjet ink contains a black pigment as the coloring agent, the weighted average value (based on mass) of the equivalents of the polymerizable groups is preferably 160 g/eq or more and 210 g/eq or less. Furthermore, when the active ray curable inkjet ink contains a red pigment as the coloring agent, the weighted average value (based on mass) of the equivalents of the polymerizable groups is preferably 200 g/eq or more and 250 g/eq or less. When the active ray curable inkjet ink contains a blue pigment as the coloring agent, the weighted average value (based on mass) of the equivalents of the polymerizable groups is preferably 200 g/eq or more and 260 g/eq or less. The yellow pigment and the black pigment tend to absorb active rays. Therefore, when a yellow pigment or a black pigment is used, in order to facilitate sufficient curing of the active ray curable inkjet ink, the weighted average value is preferably lower than when other pigments (for example, a red pigment and a blue pigment) are used. Note that the coloring agent corresponds to the coloring material in the first disclosure described above. Therefore, the coloring material in the first disclosure can be naturally substituted with the coloring agent in the present disclosure.

When the active ray polymerizable compound is, for example, acrylate, the equivalent of the polymerizable group refers to an acrylic equivalent. In addition, the weighted average value of the equivalents of the polymerizable groups refers to a value obtained by summing values calculated for all the polymerizable compounds contained in the active ray polymerizable compound—each of the values is calculated by multiplying the equivalents of the polymerizable groups of each polymerizable compound by the mass ratio of the polymerizable compound.

It is preferable that the active ray polymerizable compound includes a monofunctional polymerizable compound, and the content of the monofunctional polymerizable compound is more than 5% by mass and 40% by mass or less based on the total mass of the active ray curable inkjet ink. When the content of the monofunctional polymerizable compound is more than 5% by mass, the degree of crosslinking of the polymer of the active ray polymerizable compound is appropriately decreased, and thus the flexibility of the cured film can be further increased. Thus, the cracking by folding of the image can be further suppressed. Furthermore, when the content of the monofunctional polymerizable compound is 40% by mass or less, the degree of crosslinking is not excessively decreased, and thus a decrease in the abrasion resistance of the image can be suppressed.

At this time, it is preferable that the active ray polymerizable compound further include a polyfunctional polymerizable compound. Thus, deterioration in the abrasion resistance of the image can be further prevented. The content mass ratio (monofunctional/polyfunctional weight ratio) of the monofunctional polymerizable compound to the polyfunctional polymerizable compound is preferably 0 to 0.6, and more preferably 0.1 to 0.4.

### (Polymerizable Compound Having Glycerol Skeleton)

The polymerizable compound preferably includes a compound having a glycerol skeleton in the molecule thereof. Due to having a glycerol skeleton in the molecule thereof, the compound has a branched structure in the molecule thereof. The branched structure has, at a terminal thereof, a functional group (for example, an acryloyl group) polymerizable by active rays. Therefore, the compound may have three or more functional groups (three or more acryloyl groups). When such a compound is polymerized, the polymerized product has flexibility while having appropriate hardness. Therefore, it is considered that the formed image is less likely to be cracked even when being bent.

In the case where the polymerizable compound includes a compound having a glycerol skeleton in the molecule thereof, X+Y is preferably 3 or more and 6 or less and more preferably 3 or more and 5 or less. Furthermore, when a weighted average value (based on mass) of the number of propylene oxide groups per molecule in the polymerizable compound having a glycerol skeleton is defined as Y′, Y′ is preferably 3 or more and 3.5 or less.

The structural formula of glycerol, which is the basis of the glycerol skeleton, is shown below.

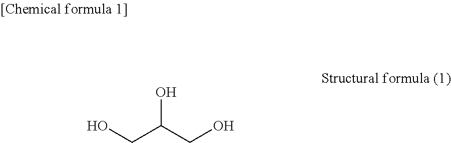

In the present disclosure, the “glycerol skeleton” refers to a moiety obtained by removing hydrogen atoms from the three hydroxy groups in the glycerol represented by the above structural formula (1). For example, the term “polyfunctional (meth)acrylate having a glycerol skeleton” refers to a compound in which a hydrogen atom of a hydroxy group is replaced by another group and which has two or more (meth)acryloyl groups at its terminals.

The polyfunctional acrylate having a glycerol skeleton may be modified by introducing a polyoxyalkylene group (for example, an EO group or a PO group) between the glycerol skeleton and the (meth)acryloyl group. In particular, the polyfunctional acrylate having a glycerol skeleton is preferably a PO-modified product into which a PO group is introduced. The PO modification number is preferably within a range of 3 to 9, and more preferably within a range of 3 to 4.

By controlling the structure of the polyoxyalkylene group, the steric structure, the molecular weight, and the like of the polyfunctional acrylate having a glycerol skeleton can be controlled, and the hardness of the polymer, the viscosity of the ink, and the like can be controlled. As a result, it is possible to further reduce cracking by folding and peeling by cutting during processing of the obtained recorded matter. In addition, in the case of an ink jet ink, the viscosity can be adjusted to a viscosity at which favorable ejectability is exhibited.

The polyfunctional (meth)acrylate having a glycerol skeleton is not particularly limited as long as it satisfies and the above definition. Examples of the polyfunctional (meth)acrylate having a glycerol skeleton include the following: glycerin diacrylate, glycerin dimethacrylate, ethylene oxide-modified glycerin diacrylate, and ethylene oxide-modified glycerin dimethacrylate; propylene oxide-modified glycerin diacrylate, propylene oxide-modified glycerin dimethacrylate, glycerin triacrylate, and glycerin trimethacrylate; and ethylene oxide-modified glycerin triacrylate, ethylene oxide-modified glycerin trimethacrylate, propylene oxide-modified glycerin triacrylate, and propylene oxide-modified glycerin trimethacrylate.

The polyfunctional (meth)acrylate having a glycerol skeleton may be a compound in which three or more (meth)acryloyl groups are added to a polyglycerol skeleton. Examples of such a compound include ethylene oxide-modified diglycerin tetraacrylate and ethylene oxide-modified diglycerin tetramethacrylate. Other examples include propylene oxide-modified diglycerin tetraacrylate, propylene oxide-modified diglycerin tetramethacrylate, and ethylene oxide-modified tetraglycerin hexaacrylate. Other examples include ethylene oxide-modified tetraglycerin hexamethacrylate, propylene oxide-modified tetraglycerin hexaacrylate, propylene oxide-modified tetraglycerin hexamethacrylate, and the like.

Examples of the polyfunctional acrylate having a glycerol skeleton are represented by the following structural formulae (2) to (5). The structural formulae (2) and (3) represent the structures of bifunctional acrylates, the structural formula (4) represents the structure of a trifunctional acrylate, and the structural formula (5) represents the structure of a tetrafunctional acrylate. The structural formula (5) is a compound in which four acryloyl groups are added to the diglycerol skeleton. Note that in the present disclosure, the acryloyl groups in the following structural formulae (2) to (5) may be methacryloyl groups.

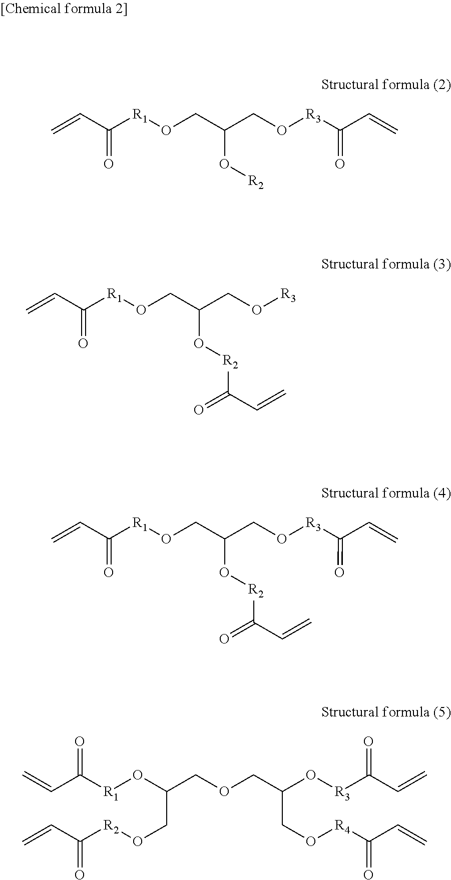

In Structural Formulae (2) to (5), R₁, R₂, R₃ and R₄ each independently represent an alkylene group, a polyoxyalkylene group, or hydrogen.

The alkylene group is not particularly limited, and examples thereof include methylene group, ethylene group, n-propylene group, isopropylene group, n-butylene group, and isobutylene group.

The polyoxyalkylene group is not particularly limited, and examples thereof include a structure represented by —(CH₂CH₂O)n- and a structure represented by —(CH₂CH₂CH₂O)n-. Note that n is an integer of 1 or more.

As a commercially available product of the polyfunctional (meth)acrylate having a glycerol skeleton, those approved by Japan Organic Resource Association as having a degree of biomass of 35% or more are are preferred.

The “degree of biomass” refers to the content (dry weight ratio) of a biomass raw material contained in a product. Examples of the approved commercially available product include glycerin diacrylate “ARONIX (registered trademark) M-920” (ratio of plant raw material: 45%, manufactured by Toagosei Co., Ltd) and glycerin triacrylate “ARONIX (registered trademark) M-930” (ratio of plant raw material: 37%, manufactured by Toagosei Co., Ltd).

The ratio of the plant raw materials is expressed by the following equation (1) based on the description of 26TREND2020 No. 23, Annual Report of Toagosei Co., Ltd.

Ratio of plant raw material [%]=(molecular weight of plant-derived material skeleton=total molecular weight)×100 Equation (1):

In addition, examples of the commercially available products include propoxylated (3) glyceryl triacrylate “SR9020NS” (manufactured by Sartomer Co., Ltd), diglycerin EO-modified acrylate “Aronix (registered trademark) M-460” (ratio of plant raw materials: 30%, manufactured by Toagosei Co., Ltd), propoxylated (3.5) glyceryl triacrylate “EM2387” (manufactured by Nagase & Co., Ltd), and ethoxylated (3) glyceryl triacrylate “EM2388” (manufactured by Nagase & Co., Ltd).

The (meth)acrylate having a glycerol skeleton is preferably three functional rather than two functional. Thus, it is possible to further reduce cracking by folding and peeling by cutting during processing of the obtained recorded matter. Furthermore, as the (meth)acrylate having a glycerol skeleton, those having different numbers of functional groups may be used in combination.

In the ink according to the present disclosure, the content of the polyfunctional (meth)acrylate having a glycerol skeleton is 20% by mass or more based on the total mass of the polymerizable compounds. In addition, it is preferable that the content of the trifunctional (meth)acrylate having a glycerol skeleton is 20% by mass or more based on the total mass of the polymerizable compounds. Thus, cracking by folding in processing of the obtained recorded matter can be reduced.

The content of the polyfunctional (meth)acrylate having a glycerol skeleton is preferably in the range of 30% by mass or more and 60% by mass or less based on the total mass of the polymerizable compounds. Thus, cracking by folding and peeling by cutting during processing of the obtained recorded matter can be further reduced. Furthermore, in the case of an inkjet ink, the viscosity can be adjusted to a viscosity at which satisfactory ejection properties are exhibited.

In the ink according to the present disclosure, the ratio (Am/Wm) of the mass Am of the polyfunctional (meth)acrylate having a glycerol skeleton to the mass Wm of the gelling agent is preferably in the range of 3.5 or more and 16 or less. Thus, cracking by folding in processing of the obtained recorded matter can be reduced. Furthermore, in the case of an inkjet ink, the viscosity can be adjusted to a viscosity at which satisfactory ejection properties are exhibited.

Furthermore, the solubility parameter (HSP value) of the entire polymerizable compound is more likely to be lowered by containing the polyfunctional (meth)acrylate having a glycerol skeleton. Thus, the compatibility between the polymerizable compound and the gelling agent is easily enhanced. That is, the solubility of the gelling agent tends to increase, and a large amount of the gelling agent tends to be contained in the ink. As a result, the pinning property of the ink can be improved. Also from the viewpoint of the pinning property of the ink, the mass ratio between the polyfunctional (meth)acrylate having a glycerol skeleton and the gelling agent is preferably within the above range.

### (Polymerizable Compound Having Benzene Ring)

It is preferable that the monofunctional polymerizable compound contains a compound having a benzene ring in the molecule thereof. It is considered that by having a benzene ring in the molecule, a stack structure of benzene rings is formed by interaction (T-T interaction) between benzene rings, and the hardness of the cured film is further increased. Therefore, when the monofunctional polymerizable compound has a benzene ring in the molecule thereof, the abrasion resistance of the image can be further increased while the cracking by folding of the image is further suppressed.

The mass of the polymerizable compound having a benzene ring based on the total mass of the polymerizable compounds is preferably 5% by mass or more and 40% by mass or less and more preferably 10% by mass or more and 30% by mass or less. The sum of the mass of the polymerizable compound having a benzene ring and the mass of the polymerizable compound having a glycerol skeleton is preferably 15% by mass or more and 60% by mass or less based on the total mass of the polymerizable compounds.

The monofunctional polymerizable compound having a benzene ring in the molecule thereof preferably has one or more and two or less benzene rings in the molecule thereof. Such a polymerizable compound can increase the strength of a cured film due to the stack of benzene rings.

The monofunctional polymerizable compound having a benzene ring in the molecule thereof may or may not contain an EO group or a PO group, but preferably contains an EO group or a PO group, and more preferably contains an EO group. When the polymerizable compound includes a polymerizable compound having a benzene ring, X+Y is preferably 3.5 or more and 7 or less, and more preferably 3.5 or more and 5.5 or less.

When the monofunctional polymerizable compound having a benzene ring contains an EO group, the weighted average value (based on mass) of the number of EO groups per molecule in the monofunctional polymerizable compound having a benzene ring is preferably 2 or more, and more preferably 4 or more. The EO group and the PO group can increase the flexibility of the cured film. In the case where the monofunctional polymerizable compound includes a benzene ring, and an EO group or a PO group, both of the improvement of the strength of the cured film due to the stacking of the benzene rings and the improvement of the flexibility of the cured film due to the EO group or the PO group can be achieved. Furthermore, the stacks of benzene rings are temporarily separated when the cured film whose flexibility is increased by the EO group or the PO group is stretched, so that the cured film is easily stretched and the folded cured film is more hardly broken (resistance against cracking by folding is further increased). On the other hand, it is considered that since the temporarily separated benzene rings are stacked again when the stretching is eliminated, a reduction in the strength of the cured film due to stretching is also less likely to occur. In such a manner, it is considered that the polymerizable compound further increases the flexibility of the cured film without decreasing the strength of the cured film and further suppresses the cracking by folding of the image. The upper limit of the weighted average value of the number of EO groups is preferably 8. The weighted average value of the number of EO groups per molecule refers to a value obtained by summing values calculated for all the monofunctional polymerizable compounds (benzene ring-containing)—each of the values is calculated by multiplying the number of EO groups in one molecule of each monofunctional polymerizable compound having a benzene ring by the mass ratio of the monofunctional polymerizable compound in the active ray polymerizable compound.

At this time, the weighted average value (based on mass) of the repeating number of the EO groups per molecule in the monofunctional polymerizable compound having a benzene ring is preferably 2 or more, and more preferably 4 or more. From the viewpoint of facilitating stacking of benzene rings, the upper limit value of the weighted average value (based on mass) of the repeating number is preferably 8.

Examples of the monofunctional polymerizable compound having a benzene ring in the molecule thereof include radically polymerizable compounds and cationically polymerizable compounds. Among these, radically polymerizable compounds are preferable. The radically polymerizable compound is preferably a (meth)acrylate.

Examples of the monofunctional (meth)acrylate having a benzene ring in the molecule thereof include the following: phenoxyethyl acrylate, 2-hydroxy-3-phenoxypropyl acrylate, and cumylphenoxyethyl acrylate; and phenol acrylate, nonylphenol (meth)acrylate, cresol (meth)acrylate, and EO- or PO-modified products thereof.

The content of the monofunctional polymerizable compound having a benzene ring in the molecule thereof is preferably 0% by mass or more and 40% by mass or less, and more preferably 5% by mass or more and 25% by mass or less based on the total mass of the active ray polymerizable compounds. When the content is 5% by mass, the degree of curing of the cured film can be further increased, and thus peeling of the image can be further suppressed. When the content is 25% by mass or less, a decrease in the flexibility of the cured film can be further suppressed, and the cracking by folding of the image can be further suppressed.

(Polymerizable Compound having Melting Point of 25 °C or Higher)

As described above, in the active ray polymerizable compound in the present disclosure, the content of the polymerizable compound having a melting point of 25 °C or higher is less than 3% by mass based on the total mass of the active ray polymerizable compounds. From the viewpoint of further enhancing the ejection stability, the content of the polymerizable compound having a melting point of 25 °C or higher is preferably less than 1% by mass, more preferably less than 0.1% by mass, and still more preferably 0% by mass.

Examples of the polymerizable compound having a melting point of 25 °C or higher include octadecyl acrylate, tris(2-acryloyloxyethyl) isocyanurate, and behenyl acrylate.

Whether or not the melting point is 25 °C or higher can be determined by whether the polymerizable compound is liquid (has fluidity) or solid (does not have fluidity) at 25 °C. Alternatively, it may be measured by a thermal analysis method (DSC, DTA) or the like.

The weight average molecular weight (Mw) of the active ray polymerizable compound is preferably 160 or more and 300 or less, more preferably 200 or more and 300 or less. The weight average molecular weight can be measured using gel permeation chromatography (GPC).

The content of the active ray polymerizable compound can be set to 1% by mass or more and 97% by mass or less based on the total mass of the active ray curable inkjet ink, and is preferably 30% by mass or more and 95% by mass or less, more preferably 50% by mass or more and 95% by mass or less, and even more preferably 70% by mass or more and 95% by mass or less.

### 1-2. Others

The active ray curable inkjet ink composition according to the present disclosure may further contain other components, such as a gelling agent, a coloring agent, a surfactant, a polymerization inhibitor, and a humectant, to the extent that the effects of the present disclosure are exhibited.

### (Gelling Agent)

In the present disclosure, the active ray curable inkjet ink may contain a gelling agent. When the active ray curable inkjet ink contains a gelling agent, the ink undergoes sol-gel phase transition (before irradiation with active ray). Specifically, the gelling agent refers to a compound that is dissolved in the active ray polymerizable compound contained in the ink when the ink containing the gelling agent is heated (for example, 80 °C), and is crystallized in the ink to gel the ink at around room temperature (for example, 35 °C).

The gelling agent is preferably crystallized in the ink to form a structure in which the active ray polymerizable compound is included in a three dimensional space formed by the gelling agent crystallized in a plate shape (such a structure is hereinafter referred to as a “card house structure”). When the card house structure is formed, the liquid active ray polymerizable compound is retained in the space, so that the gelation property of the ink is further enhanced. Thus, dots formed by adhesion of the ink to a recording medium are less likely to wet-spread, thereby enhancing the pinning property of the ink.

Examples of gelling agents that can make it easier to form a card house structure by crystallization include the following: aliphatic ketones, aliphatic esters, glycerol-based compounds, pentaerythritol-based compounds, petroleum-based waxes, plant-based waxes, animal-based waxes, and mineral-based waxes; hydrogenated castor oil, modified waxes, higher fatty acids, higher alcohols, hydroxystearic acid, fatty acid amides including N-substituted fatty acid amides and special fatty acid amides; and higher amines, sucrose fatty acid esters, synthetic waxes, dibenzylidene sorbitol, dimer acid, and dimer diol.

Of these, from the viewpoint of increasing the polarity to further increase the solubility in the active ray polymerizable compound, the gelling agent is preferably an aliphatic ketone, an aliphatic ester, a higher fatty acid, and a higher alcohol, and more preferably an aliphatic ketone and an aliphatic ester. Only one gelling agent may be contained, or two or more gelling agents may be contained in combination.

Examples of the aliphatic ketone include dibehenyl ketone, distearyl ketone, dieicosyl ketone, dipalmityl ketone, dilauryl ketone, dimyristyl ketone, myristyl palmityl ketone, and palmityl stearyl ketone.

Examples of the aliphatic ester include the following: behenyl behenate, icosyl icosanoate, stearyl stearate, palmityl stearate, myristyl myristate, and cetyl myristate; fatty acid esters of monoalcohols such as oleyl palmitate, glycerin fatty acid esters, and sorbitan fatty acid esters; and fatty acid esters of polyhydric alcohols, such as propylene glycol fatty acid esters, ethylene glycol fatty acid esters, and polyoxyethylene fatty acid esters.

Examples of the higher fatty acid include behenic acid, arachidic acid, stearic acid, palmitic acid, myristic acid, lauric acid, oleic acid, and erucic acid.

Examples of the higher alcohol include stearyl alcohol and behenyl alcohol.

Among the aliphatic ketones and the aliphatic esters, an aliphatic ketone represented by the following general formula (G1) or an aliphatic ester represented by the following general formula (G2) is more preferable from the viewpoint of further enhancing the gelation property.

Rₐ—CO—R_{b} General formula (G1):

R_{c}—COO—Rₐ General formula (G2):

In general formula (G1), Rₐ and R_{b} independently represent a linear hydrocarbon group having 12 or more and 22 or less carbon atoms, and in general formula (G2), R_{c} and R_{d} independently represent a linear hydrocarbon group having 12 or more and 22 or less carbon atoms.

In general formulae (G1) and (G2), when the number of carbon atoms of Rₐ to R_{d} is equal to or greater than 12, the crystallinity of the gelling agent represented by general formula (G1) and general formula (G2) is further increased, and a more sufficient space is generated in the card house structure. Therefore, the active ray polymerizable compound is more likely to be sufficiently included in the space, and the gelation property and the pinning property of the ink are further improved.

In addition, when the number of carbon atoms of Rₐ to R_{d} is 22 or less, the melting points of the gelling agent represented by general formula (G1) and general formula (G2) are not excessively increased, and the solubility of the gelling agent is increased.

Examples of the aliphatic ketone represented by the general formula (G1) include the following: dibehenyl ketone (numbers of carbon atoms: 21-22), distearyl ketone (numbers of carbon atoms: 17-18), and dieicosyl ketone (numbers of carbon atoms: 19-20); dipalmityl ketone (numbers of carbon atoms: 15-16), dimyristyl ketone (numbers of carbon atoms: 13-14), and dilauryl ketone (numbers of carbon atoms: 11-12); lauryl myristyl ketone (numbers of carbon atoms: 11-14), lauryl palmityl ketone (11-16), myristyl palmityl ketone (13-16), and myristyl stearyl ketone (13-18); myristyl behenyl ketone (13-22) and palmityl stearyl ketone (15-18); and valmityl behenyl ketone (15-22) and stearyl behenyl ketone (17-22). The number of carbon atoms in the above parentheses represents the number of carbon atoms of each of two hydrocarbon groups separated by a carbonyl group.

Examples of the aliphatic ester represented by the general formula (G2) include the following: behenyl behenate (numbers of carbon atoms: 21-22), icosyl icosanoate (numbers of carbon atoms: 19-20), and stearyl stearate (numbers of carbon atoms: 17-18); palmityl stearate (numbers of carbon atoms: 17-16), lauryl stearate (numbers of carbon atoms: 17-12), and cetyl palmitate (numbers of carbon atoms: 15-16); stearyl palmitate (numbers of carbon atoms: 15-18), myristyl myristate (numbers of carbon atoms: 13-14) and cetyl myristate (numbers of carbon atoms: 13-16); octyldodecyl myristate (numbers of carbon atoms: 13-20), stearyl oleate (numbers of carbon atoms: 17-18), and stearyl erucate (numbers of carbon atoms: 21-18); and stearyl linoleate (numbers of carbon atoms: 17-18), behenyl oleate (numbers of carbon atoms: 18-22), and arachidyl linoleate (numbers of carbon atoms: 17-20). The number of carbon atoms in the above parentheses represents the number of carbon atoms of each of the two hydrocarbon groups separated by the ester group.

The content of the gelling agent is preferably 0.5% by mass or more and 10% by mass or less, more preferably 1.5% by mass or more and 8% by mass or less, based on the total mass of the active ray curable inkjet ink. When the content is 1.5% by mass or more, the gelation property and the pinning property of the ink can be further enhanced. In addition, when the content is 8% by mass or less, the solubility of the gelling agent in the active ray polymerizable compound can be further increased.

### (Coloring Agent)

The coloring agent is a dye or a pigment, but a pigment is preferable because it has satisfactory dispersibility in constituent components of the ink and is excellent in weather resistance. The pigments may be selected according to a color or the like of an image to be formed, and, for example, from yellow pigment, red pigment, blue pigment, black pigment and white pigment.

Examples of yellow pigments include the following: Pigment Yellow (PY) 1, 3, 12, 13, 14, 17, 34, 35, 37, 55, 74, 81, 83, 93, 94,95, 97, 108, 109, 110, 137, 138, 139, 153, 154, 155, 157, 166, 167, 168, 180, 185, 193, and the like. Among these, PY185 and PY150 are preferable from the viewpoint of further reducing the amount of impurities in the ink composition and further increasing the electrical resistance value of the insulating film.

Examples of red pigments include the following: Pigment Red (PR) 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 202, 208, 216, 226, 257, Pigment Violet (PV) 3, 19, 23, 29, 30, 37, 50, 88, Pigment Orange (PO) 13, 16, 20, 36, and the like. Among these, from the viewpoint of further reducing the impurity amount in the ink composition and further increasing the electric resistance value of the insulating film, PR122 and PV19 are preferable.

Examples of blue pigments include Pigment Blue (PB) 1, 15, 15:1, 15:2, 15:3, 15:4, 15:6, 16, 17:1, 22, 27, 28, 29, 36, and 60. Among these, PB15:3 and PB15:4 are preferable from the viewpoint of further reducing the amount of impurities in the ink composition and further increasing the electrical resistance value of the insulating film.

Examples of the black pigment include C. I. Pigment Black (hereinafter, also simply referred to as “PBk”) 7, PBk26, and PBk28.

The white pigment may be any pigment that imparts a white color to a cured film formed by curing a white ink. Examples of the white pigment include inorganic pigments such as titanium oxide, zinc oxide, calcium carbonate, barium sulfate, and aluminum hydroxide. Among these, titanium oxide is preferable.

The crystal form of the titanium oxide may be any of a rutile type, an anatase type, and a brookite type. However, from the viewpoint of making it easier to reduce the particle diameter of the white pigment, the anatase type having a small specific gravity is preferable. In addition, from the viewpoint of further enhancing the concealing property of an image to be formed, a rutile type having a large refractive index in the visible light region is preferable.

The content of the coloring agent is preferably 0.1% by mass or more and 10% by mass or less and more preferably 1% by mass or more and 5% by mass or less based on the total mass of the ink composition. The content of the white pigment is preferably 3% by mass or more and 8% by mass or less.

### (Pigment Dispersant)

The active ray-curable ink may contain a pigment dispersant for dispersing a pigment. Examples of the pigment dispersant include the following: hydroxyl group-containing carboxylic acid esters, salts of a long-chain polyaminoamide and a high-molecular-weight acid ester, salts of a high-molecular-weight polycarboxylic acid, and salts of a long-chain polyaminoamide and a polar acid ester; high molecular weight unsaturated acid esters, high molecular weight copolymers, modified polyurethanes, modified polyacrylates, and polyether ester type anionic surfactants; and naphthalenesulfonic acid-formalin condensate salts, aromatic sulfonic acid-formalin condensate salts, polyoxyethylene alkyl phosphate esters, polyoxyethylene nonylphenyl ether, and stearylamine acetate.

The content of the pigment dispersant is preferably 10% by mass or more and 200% by mass or less, more preferably 20% by mass or more and 100% by mass or less, based on the total mass of the pigment. When the content of the dispersant is 10% by mass or more based on the total mass of the pigment, the dispersion stability of the pigment is enhanced, and when the content of the dispersant is 200% by mass or less based on the total mass of the pigment, the ejection property of the ink from an inkjet head is readily stabilized.

### (Active Ray Polymerization Initiator)

In the present embodiment, the active ray curable inkjet ink may contain an active ray polymerization initiator (hereinafter, simply referred to as a “polymerization initiator”). The active ray polymerization initiator corresponds to the photopolymerization initiator in the first disclosure described above. Therefore, the photopolymerization initiator in the first disclosure can be naturally replaced with the active ray polymerization initiator in the present disclosure. The polymerization initiator may be any polymerization initiator that can initiate polymerization of the active ray polymerizable compound described above upon irradiation with active rays. For example, when the active ray curable inkjet ink contains a radically polymerizable compound, the polymerization initiator can be a radical polymerization initiator, and when the active ray-curable ink contains a cationically polymerizable compound, the polymerization initiator can be a cationic polymerization initiator (photoacid generator). Note that when the active ray curable inkjet ink can be sufficiently cured without a polymerization initiator, such as when the active ray curable inkjet ink is cured by irradiation with an electron beam, no polymerization initiator is required.

The radical polymerization initiator includes an intramolecular bond cleavage type radical polymerization initiator and an intramolecular hydrogen abstraction type radical polymerization initiator.

Examples of the intramolecular bond cleavage type radical polymerization initiator include the following: diethoxyacetophenone, 2-hydroxy-2-methyl-1-phenylpropan-1-one, and benzyl dimethyl ketal; 1-(4-isopropylphenyl)-2-hydroxy-2-methylpropan-1-one, and 4-(2-hydroxyethoxy)phenyl-(2-hydroxy-2-propyl) ketone; acetophenone-based initiators including 1-hydroxycyclohexyl-phenyl ketone, 2-methyl-2-morpholino (4-methylthiophenyl) propan-1-one, and 2-benzyl-2-dimethylamino-1-(4-morpholinophenyl)-butanone, and the like; benzoins, including benzoin, benzoin methyl ether, benzoin isopropyl ether, and the like; and acylphosphine oxide-based initiators including 2,4,6-trimethylbenzoin diphenylphosphine oxides and the like, and benzyl and methylphenyl glyoxy esters and the like.

Examples of the intramolecular hydrogen abstraction type radical polymerization initiator include the following: benzophenone, methyl o-benzoylbenzoate, 4-phenylbenzophenone, 4,4′-dichlorobenzophenone, hydroxybenzophenone, and 4-benzoyl-4′-methyl-diphenyl sulfide; benzophenone-based initiators including acrylated benzophenone, 3,3′,4,4′-tetra(t-butylperoxycarbonyl)benzophenone, and 3,3′-dimethyl-4-methoxybenzophenone, and the like; thioxanthone-based initiators including 2-isopropylthioxanthone, 2,4-dimethylthioxanthone, 2,4-diethylthioxanthone, and 2,4-dichlorothioxanthone, and the like. aminobenzophenone-based initiators including Michler's ketone, 4,4′-diethylaminobenzophenone, and the like; and 10-butyl-2-chloroacridone, 2-ethylanthraquinone, 9,10-phenanthrenequinone, camphorquinone, and the like.

Examples of the cationic polymerization initiator include a photoacid generator. Examples of the photoacid generators include the following: B(C₆F)₄—, PF₆—, AsF₆—, SbF₆—, and CF₃SO₃— salts of aromatic onium compounds including diazonium, ammonium, iodonium, sulfonium, and phosphonium, sulfonates that generate sulfonic acid, and halides that photogenerate hydrogen halide; and iron-allene complexes and the like.

The content of the polymerization initiator is not particularly limited as long as it is within a range in which the active ray curable inkjet ink is sufficiently cured by irradiation with active rays (e.g., ultraviolet rays) and the coatability onto the surface of a recording medium is not deteriorated. For example, the content of the polymerization initiator is preferably 0.1% by mass or more and 20% by mass or less, more preferably 1% by mass or more and 10% by mass or less, based on the total mass of the active ray curable inkjet ink.

### (Polymerization Inhibitor)

In the present embodiment, the active ray curable inkjet ink may contain a polymerization inhibitor.

Examples of the polymerization inhibitor include the following: (alkyl) phenol, hydroquinone, catechol, resorcin, p-methoxyphenol, t-butylcatechol, t-butylhydroquinone, and pyrogallol; 1,1-picrylhydrazyl, phenothiazine, p-benzoquinone, nitrosobenzene, 2,5-di-t-butyl-p-benzoquinone, and dithiobenzoyl disulfide; picric acid, cupferron, aluminum N-nitrosophenylhydroxylamine, tri-p-nitrophenylmethyl, and N-(3-oxyanilino-1,3-dimethylbutylidene) aniline oxides; and dibutylcresol, cyclohexanone oxime cresol, guaiacol, o-isopropylphenol, butyraldoxime, methyl ethyl ketoxime, cyclohexanone oxime, and the like.

The content of the polymerization inhibitor is not particularly limited, but is preferably 0.05% by mass or more and 10.00% by mass or less based on the total mass of the active ray curable inkjet ink.

### (Surfactant)

In the present embodiment, the active ray curable inkjet ink may contain a surfactant for adjusting the surface tension.

Examples of the surfactant include anionic surfactants including dialkylsulfosuccinates, alkylnaphthalenesulfonates, and fatty acid salts, nonionic surfactants including polyoxyethylene alkyl ethers, polyoxyethylene alkyl allyl ethers, acetylene glycols, and polyoxyethylene-polyoxypropylene block copolymers, cationic surfactants including alkylamine salts and quaternary ammonium salts, silicone-based surfactants, and fluorine-based surfactants.

The content of the surfactant is not particularly limited, but is preferably 0.001% by mass or more and 10% by mass or less, more preferably 0.001% by mass or more and 1.0% by mass or less, based on the total mass of the active ray curable inkjet ink.

In the present disclosure, the active ray curable inkjet ink may contain, when necessary, a fixing resin, a viscosity modifier, a specific resistance modifier, a film forming agent, a UV absorber, an antioxidant, a discoloration inhibitor, a fungicide, a rust inhibitor, and the like, in addition to the above-described components.

### 1-3. Physical Properties of Active Ray Curable Inkjet Ink

The viscosity of the active ray-curable ink at 60 °C is preferably 10 mPa·s or more and 25 mPa·s or less, more preferably 10 mPa·s or more and 15 mPa·s or less. Thus, in the ink jet head, it is possible to improve the ejection property when the ink is heated and ejected. In the present disclosure, the viscosity can be adjusted to fall within the above range by setting X+Y to satisfy the above value. Furthermore, when the ink contains a gelling agent, the viscosity can also be adjusted to fall within the above range by adjusting the content of the gelling agent.

When the active ray-curable ink contains a gelling agent, the viscosity of the active ray-curable ink at 80 °C is preferably 6 mPa·s or more and 25 mPa·s or less, more preferably 7 mPa·s or more and 15 mPa·s or less. Thus, in the ink jet head, it is possible to improve the ejection property when the ink is heated and ejected.

The viscosity can be measured by a rheometer. For example, the active ray-curable ink is heated to 100 °C, and the ink is cooled to 20 °C under conditions of a shear rate of 11.7 (l/s) and a temperature lowering rate of 0.1 °C/s while measuring the viscosity with a stress-control-type rheometer (manufactured by AntonPaar, Physica MCR301 (cone plate diameter: 75 mm, cone angle: 1.0°) to obtain a temperature change curve of viscosity. The viscosity can be determined by reading the viscosity at 60 °C from the obtained temperature change curve.

### 1-4. Method for Preparing Active Ray Curable Inkjet Ink

The active ray curable inkjet ink can be prepared by mixing the above-described active ray polymerizable compound, the gelling agent, and optional other components under heating. At this time, the obtained mixed liquid is preferably filtered through a predetermined filter. Note that when an ink containing a pigment is prepared, it is preferable to prepare a pigment dispersion liquid containing the pigment and an active ray polymerizable compound and then mix the pigment dispersion liquid with other components. The pigment dispersion liquid may further contain a dispersant.

The pigment dispersion liquid can be prepared by dispersing a pigment in an active ray polymerizable compound. The pigment may be dispersed using, for example, a ball mill, a sand mill, an attritor, a roll mill, an agitator, a Henschel mixer, a colloid mill, an ultrasonic homogenizer, a pearl mill, a wet jet mill, or a paint shaker. At this time, a dispersant may be added.

Note that in the case of using a plurality of types of active ray polymerizable compounds, the active ray polymerizable compounds may be mixed in advance to produce an active ray polymerizable composition, and then the active ray polymerizable composition, the gelling agent, and any other components may be mixed under heating.

### 2. Image Forming Method

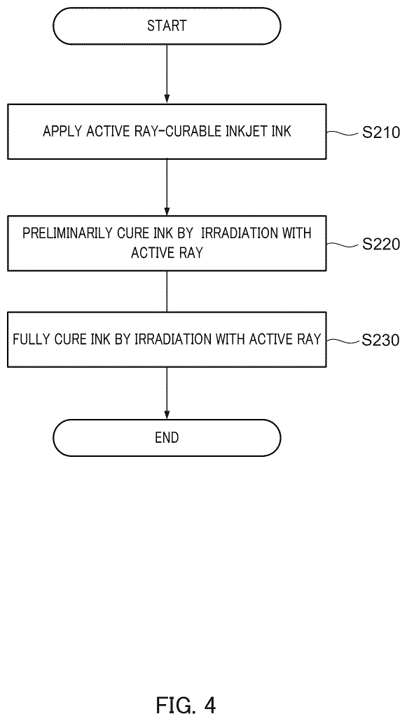

FIG. 4 is a flowchart illustrating an image forming method according to the present disclosure. The image forming method according to the present disclosure includes a step of ejecting droplets of the above-described active ray curable inkjet ink from an inkjet head to apply the droplets onto a surface of a recording medium (step S210). In addition, the image forming method includes a step (step S220) of preliminarily irradiating the applied droplets of the active ray curable inkjet ink with active ray to preliminarily cure the droplets. The method also includes a step of fully curing the preliminarily cured product (step S230).

### 2-1. Step of Applying Active Ray Curable Inkjet Ink to Recording Medium (Step S210)

In this step, the above-described active ray curable inkjet ink is ejected from an inkjet head and applied to the surface of a recording medium (at a position corresponding to an image to be formed).

The method of ejecting ink from the inkjet head may be either an on-demand method or a continuous method. The inkjet head of the on-demand method may be of an electro-mechanical conversion type, such as a single cavity type, a double cavity type, a bender type, a piston type, a share mode type, and a shared wall type. In addition, an electro-thermal conversion type such as a thermal ink jet type and a bubble jet (“bubble jet” is a registered trademark of Canon Inc) type may be used. In addition, the ink jet head may be either a scan type or a line type ink jet head.

When the ink contains a gelling agent, the droplets of the active ray-curable ink are ejected from the inkjet head in a heated and solated state, and therefore the following conditions are preferred. That is, the temperature of the ink when the inkjet head is filled with the ink is preferably set to be equal to or higher than the gelation temperature of the ink +10 °C and equal to or lower than the gelation temperature +30 °C. When the temperature of the active ray-curable ink in the inkjet head is the gelation temperature +10 °C or more, a reduction in ejection properties due to gelation of the ink in the inkjet head or on the nozzle surface is less likely to occur. On the other hand, when the temperature of the ink in the inkjet head is the gelation temperature +30 °C or less, deterioration of the components due to a high temperature is less likely to occur.

The method for heating the active ray curable inkjet ink is not particularly limited. For example, at least any one of an ink supply system such as an ink tank, a supply pipe, and a front chamber ink tank immediately before the head, a pipe with a filter, a piezo head, and the like constituting the head carriage can be heated by a panel heater, a ribbon heater, heat-retaining water, and the like.

The ejected droplet amount of the active ray curable inkjet ink is preferably 2 μL or more and 20 μL or less from the viewpoint of further increasing the recording speed and image quality.

The recording medium is not particularly limited, and in addition to normal non-coated paper and coated paper, synthetic paper YUPO (“YUPO” is a registered trademark of YUPO CORPORATION), various plastics used for flexible packaging, and films thereof can be used. Examples of the various types of plastic films include PP films, PET films, OPS films, OPP films, ONy films, PVC films, PE films, and TAC films. As other plastics, polycarbonate, (meth)acrylic resin, ABS, polyacetal, PVA, rubbers, and the like can be used.

The application of the active ray curable inkjet ink to the recording medium may be performed by landing the ejected ink on the recording medium as it is, or by landing the ejected ink on an intermediate transfer member to form an intermediate image and transferring the intermediate image from the intermediate transfer member to the recording medium.

### 2-2. Step of Preliminarily Cure and Fully Cure Active Ray Curable Inkjet Ink (Step S220, S230)

In this step, the droplets of the active ray curable inkjet ink applied to the recording medium in step S210 are irradiated with active rays to preliminarily cure and fully cure the droplets. Thus, an image formed of a cured film of the active ray curable inkjet ink is formed. Furthermore, the formed image is less likely to be cracked by folding, and has higher abrasion resistance and higher internal curability.

The active rays can be selected from for example, electron beams, ultraviolet rays, x-rays, y-rays, and X-rays, and are preferably ultraviolet rays or electron beams. The ultraviolet rays are preferably light having peak wavelengths in a range of 360 nm to 410 nm inclusive. Furthermore, the ultraviolet rays are preferably emitted from an LED light source. An LED emits less radiant heat than a conventional light source (e.g., a metal halide lamp). Therefore, when the LED emits active rays, the ink is less likely to be dissolved, and gloss unevenness and the like are less likely to occur.

When the total integrated light amount is defined as 100%, the integrated light amount ratio by the preliminary irradiation is L1, and the integrated light amount ratio by the main irradiation is L2, L1:L2 is preferably 20%: 80% to 40%: 60%, and preferably 20%: 80% to 30%: 70%.

The total integrated light amount of the preliminary irradiation and the main irradiation may be appropriately set according to the application amount of the ink or the like, and is not particularly limited. The total integrated light amount can be, for example, 400 mJ/cm² or more, 500 mJ/cm² or more, or 600 mJ/cm² or more. The upper limit of the total integrated light amount may be, for example, 800 mJ/cm² or less. Further, from the viewpoint of suppressing energy consumption, the total integrated light amount is preferably equal to or less than 600 mJ/cm².

FIGS. 2A to 2C are schematic irradiance distributions for explaining an example of the integrated light amount. That is, FIGS. 2A to 2C are schematic irradiance distributions for explaining an example of the integrated light amount in the first disclosure and the present disclosure. The horizontal axes of FIGS. 2A to 2C indicate conveyance distance of a recording media from the upstream end portion of the active ray irradiation region, and the vertical axes indicate irradiance. The one dot chain line in FIGS. 2A to 2C indicates the center position when the active ray irradiation region is divided into two equal parts in the conveyance direction of the recording sheet. The left half in FIGS. 2A to 2C indicates the upstream side (preliminary irradiation), and the right half indicates the downstream side (main irradiation).

As illustrated in FIG. 2A, the irradiance distribution may be a smooth bimodal distribution having one peak in the upstream portion and one peak in the downstream portion. Furthermore, as illustrated in FIG. 2B, the irradiance distribution may be a distribution having a peak only in the downstream portion. Alternatively, as illustrated in FIG. 2C, the distribution may be such that the irradiance changes stepwise. In the irradiance distribution of FIG. 2B, the irradiance gradually increases as the conveyance distance increases in the preliminary irradiation, and reaches a peak in the main irradiation. Here, the integrated light amount can be calculated by multiplying the irradiance by the irradiation time of the active rays. In the present embodiment, since the conveyance speed of the recording medium is constant, a value obtained by multiplying the irradiance by the conveyance distance can be treated as a value corresponding to the integrated light amount. That is, in FIGS. 2A to 2C, by comparing the area of the shaded portion in the left half with the area of the shaded portion in the right half, it is possible to compare the integrated light amount on the upstream side with the integrated light amount on the downstream side. In the present embodiment, the area of the shaded portion in the right half (downstream side) is larger than the area of the shaded portion in the left half (downstream side).

### 3. Image Forming Apparatus

An image forming apparatus 100 capable of carrying out the above-described image forming method will be described below.

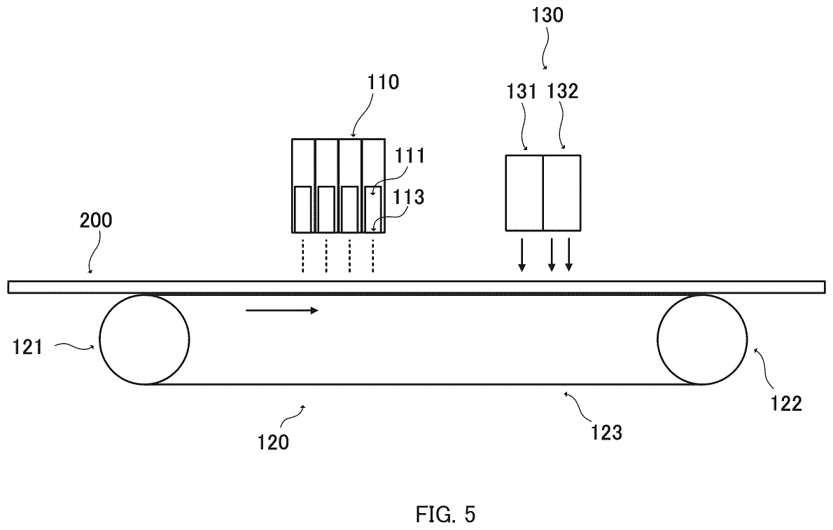

FIG. 5 is a schematic diagram illustrating the configuration of the image forming apparatus 100 according to the present disclosure. As illustrated in FIG. 5, the image forming apparatus 100 includes an inkjet head 110, a conveyance section 120, and an irradiation section 130. The irradiation section 130 includes a preliminary irradiation section 131 and a main irradiation section 132. Note that in FIG. 5, an arrow indicates a conveyance direction of the recording medium.

The inkjet head 110 includes a nozzle surface 113 on which the nozzle 111 is provided, on the surface facing the conveyance section 120 when forming an image, and ejects an active ray curable inkjet ink onto the recording medium 200 conveyed by the conveyance section 120. From the viewpoint of enhancing the ejection properties of the active ray curable inkjet ink, the inkjet head 110 may have a temperature adjustment means (i.e., temperature adjuster) for adjusting the temperature of the ink to adjust the ink to have a low viscosity. Examples of the temperature adjusting means include heating means using a panel heater, a ribbon heater, and heat-retaining water.

The inkjet head 110 may be a scanning inkjet head whose width in a direction orthogonal to the conveyance direction of the recording medium is smaller than the recording medium 200. In addition, the inkjet head 110 may be a line-type ink jet head whose width in a direction orthogonal to the conveyance direction of the recording medium is larger than the recording medium 200.

The nozzle 111 includes an ejection port on the nozzle surface 113. The number of nozzles 111 may be equal to or greater than the number of inks used for image formation (for example, four).

The conveyance section 120 conveys the recording medium 200 in such a way that, directly below the inkjet head 110 in the vertical direction, the recording medium 200 facing the inkjet head 110 moves when an image is formed. For example, the conveyance section 120 includes a driving roller 121, a driven roller 122, and a conveyance belt 123.

The irradiation section (i.e., irradiator) 130 includes a preliminary irradiation section 131 and a main irradiation section 132. The preliminary irradiation section 131 preliminarily cures the active ray curable inkjet ink, and the main irradiation section 132 fully cures the preliminarily cured ink. The integrated light amount of the preliminary irradiation section is smaller than the integrated light amount of the main irradiation section. By performing the preliminary irradiation and the main irradiation in this manner, the internal curability of the image is enhanced. The “preliminary irradiation section and the” main irradiation section” are not particularly limited as long as they can perform the preliminary irradiation and the main irradiation. The “preliminary irradiation section and the main irradiation section” may be separate irradiators independent of each other as illustrated in FIG. 5, or may be an upstream portion and a downstream portion of one irradiator. In this case, the preliminary irradiation section is disposed upstream in the conveyance direction, and the main irradiation section is disposed downstream of the preliminary irradiation section. Each irradiation section irradiates the ink on the conveyed recording medium with active rays.

The preliminary irradiation section 131 on the upstream side and the main irradiation section 132 on the downstream side can be configured, for example, by varying the arrangement density of active ray irradiation sources (for example, UV irradiation LEDs) that emit active rays. For example, it is sufficient that the preliminary irradiation section 131 has a lower arrangement density of the active ray irradiation sources and the main irradiation section 132 has a higher arrangement density of the active ray irradiation sources. In addition, the preliminary irradiation section 131 and the main irradiation section 132 can be configured to have different distances from the recording medium to which the ink is applied. For example, the preliminary irradiation section 131 may have a longer distance between the active ray irradiation source and the recording medium, and the main irradiation section may have a shorter distance between the active ray irradiation source and the recording medium.

In addition to the above-described configuration, the image forming apparatus 100 may include an ink tank (not illustrated) for storing the active ray-curable ink before ejection. Furthermore, an ink channel (not illustrated) that allows the ink tank and the inkjet head 110 to communicate with each other in such a way that the ink can flow therethrough may be provided. Furthermore, a controller (not illustrated) that controls the operation of the inkjet head 110, the conveyance section 120, and the irradiation section 130 may be included.

Furthermore, the image forming apparatus 100 may include an intermediate transfer member and a transfer section (both not illustrated). At this time, the inkjet heads 110 eject the active ray curable inkjet ink onto the intermediate transfer member so that the ink lands on the surface of the intermediate transfer member to form an intermediate image on the surface of the intermediate transfer member. The intermediate image is thus formed by aggregation of droplets of the active ray curable inkjet ink. Thereafter, the transfer section transfers the intermediate image from the surface of the intermediate transfer member to the surface of the recording medium. Then, the irradiation section 130 irradiates the intermediate image transferred onto the surface of the recording medium with active ray to cure the liquid droplets of the active ray curable inkjet ink.

As is clear from the above description, according to the present disclosure, the following image forming apparatus and image forming method can be provided.
[1] An image forming apparatus including an inkjet ink that contains a polymerizable compound polymerizable by an active ray, wherein: a content of a polymerizable compound having a melting point of 25 °C or higher is less than 3% by mass based on a total mass of the polymerizable compound; when a weighted average value (based on mass) of the number of ethylene oxide groups per molecule in the polymerizable compound is X and a weighted average value (based on mass) of the number of propylene oxide groups per molecule in the polymerizable compound is Y, X+Y is 3 or more and 9 or less; and
the image forming apparatus further comprising a preliminary irradiator to preliminarily cure the inkjet ink, and a main irradiator to fully cure the inkjet ink preliminarily cured.
[2] The image forming apparatus according to [1], wherein the inkjet ink has a viscosity at 60 °C of 10 mPa·s or more and 25 mPa·s or less.
[3] The image forming apparatus according to [1] or [2], wherein the inkjet ink contains a gelling agent.
[4] The image forming apparatus according to any one of [1] to [3], wherein a weighted average value (based on mass) of an equivalent of a polymerizable group in the polymerizable compound is 130 g/eq or more and 300 g/eq or less.
[5] The image forming apparatus according to any one of [1] to [4], wherein a sum of a mass of the polymerizable compound having a benzene ring and a mass of a polymerizable compound having a glycerol skeleton is 15% by mass or more and 60% by mass or less based on a total mass of the polymerizable compound.
[6] The image forming apparatus according to any one of [1] to [5], wherein the X+Y is 3.5 or more and 7 or less, and a mass of a polymerizable compound having a benzene ring is 5% by mass or more and 40% by mass or less based on a total mass of the polymerizable compound.
[7] The image forming apparatus according to any one of [1] to [6], wherein: the X+Y is 3.5 or more and 5.5 or less; a weighted average value (based on mass) of an equivalent of a polymerizable group in the polymerizable compound is 150 g/eq or more and 250 g/eq or less; and a mass of a polymerizable compound having a benzene ring based on a total mass of the polymerizable compound is 10% by mass or more and 30% by mass or less.
[8] The image forming apparatus according to any one of [1] to [7], wherein: the X+Y is 3 or more and 6 or less; a weighted average value (based on mass) of an equivalent of a polymerizable group in the polymerizable compound is 140 g/eq or more and 300 g/eq or less; and a mass of a polymerizable compound having a glycerol skeleton based on a total mass of the polymerizable compound is 20% by mass or more and 55% by mass or less.
[9] The image forming apparatus according to any one of [1] to [8], wherein: the X+Y is 3 or more and 5 or less; and when a weighted average value (on a mass basis) of the number of propylene oxide groups per molecule in a polymerizable compound having a glycerol skeleton is represented by Y′, Y′ is 3 or more and 3.5 or less.
[10] The image forming apparatus according to any one of [1] to [11], wherein when an integrated light amount ratio in the preliminary irradiation section is L1, and an integrated light amount ratio in the main irradiation section is L2, L1:L2 is 20%: 80% to 40%: 60%.
[11] The image forming apparatus according to any one of [1] to [12], wherein a total integrated light amount by the preliminary irradiation section and the main irradiation section is equal to or smaller than 600 mJ/cm².
[12] An image forming method using the image forming apparatus according to any one of [1] to [11].

### Modification Example

Note that each of the above disclosures shows an example of the present invention. The present invention is not limited to each of the above disclosures, and it goes without saying that various other embodiments are possible within the scope of the idea of the present invention.

Further, the first disclosure and the second disclosure may be combined.

For example, at least a part of the configuration of the inkjet ink of the first disclosure (e.g., the photopolymerizable compound) may be replaced with or added to at least a part of the configuration of the inkjet ink of the second disclosure (e.g., the active ray polymerizable compound). For example, the photopolymerizable compounds included in the inkjet ink of the first disclosure may satisfy the conditions that X+Y is 3 or more and 9 or less and the content of the polymerizable compound having a melting point of 25 °C or more is less than 3% by mass based on the total mass of the polymerizable compounds.

In addition, the configuration of the irradiation condition or at least a part of the irradiation section of the image forming apparatus in the second disclosure may be replaced with or added to the irradiation condition or at least a part of the irradiation section of the image forming apparatus in the first disclosure. For example, in the step of curing an inkjet ink of the second disclosure, when an active ray irradiation region is divided into two in a central portion of the active ray irradiation region in a conveyance direction of a recording medium, active rays may be emitted in such a way that an integrated amount of active rays in a downstream portion of the active ray irradiation region is larger than an integrated amount of active rays in an upstream portion of the active ray irradiation region. In addition, the maximum irradiance of the active rays in the upstream portion may be set to be in a range of 0.01 W/cm² or more and less than 1.5 W/cm², and the maximum irradiance of the active rays in the downstream portion may be set to be in a range of 4 W/cm² or more and less than 8 W/cm². Examples

The present invention is described in more detail below with reference to examples. These examples are not to be construed as limiting the scope of the present invention.

### Example/Comparative Example Related to First Disclosure

### Material of Inkjet Ink

As the photopolymerizable compounds, 25% by mass of TPGDA (tripropylene glycol diacrylate), 30% by mass of 2PO-NPGDA (2PO-modified neopentyl glycol diacrylate), and 27.3% by mass of NPGDA (neopentyl glycol diacrylate) were used. As the polymerization initiator, 3.0% by mass of IRGACURE 819 (manufactured by BASF) was used. As the polymerization inhibitor, 0.15% by mass of Irgastub UV10 (manufactured by BASF) was used. As the surfactant, 0.05% by mass of TSF-4452 (Momentive Performance Materials Inc.) was used. As the gelling agent, 4.0% by mass of Emalex CC-18 (stearic acid ester; Nippon Emulsion Co., Ltd.) was used. As a pigment dispersion liquid, 10% by mass of a pigment dispersion liquid prepared by the following method was used.

### Preparation of Pigment Dispersion Liquid

In a stainless steel beaker, 9% by mass of Ajisper PB824 (manufactured by Ajinomoto Fine-Techno Co., Inc) and 71% by mass of tripropylene glycol diacrylate (APG-200, manufactured by Shin-Nakamura Chemical Co., Ltd.) were placed, and while heating on a hotplate at 65 °C, the mixture was stirred under heating for 1 hour to be dissolved. The resulting solution was cooled to room temperature, and then, 20 parts by mass of Pigment Black 7 (manufactured by Mitsubishi Chemical Corporation, #52) was added thereto, and the mixture was placed in a glass bottle together with 200 g zirconia beads having a diameter of 0.5 mm, and the glass bottle was sealed. The components were subjected to a dispersion treatment for 5 hours with a paint shaker, and then the zirconia beads were removed to obtain a pigment dispersion liquid.

### Preparation of Inkjet Ink

The materials were mixed together in accordance with the above-described component composition, and the mixture was heated to 80 °C and stirred. Thereafter, while the mixture was heated, the mixture was filtered through a Teflon (registered trademark)) 3-μm membrane filter (manufactured by ADVANTEC (registered trademark)) to obtain inkjet ink 1.

Inkjet ink 2 was obtained in the same manner as inkjet ink 1, except that, in the method for preparing inkjet ink 1, instead of the gelling agent, the amount of each monomer was increased while maintaining the ratio of the monomer composition.

### Formation of Image

The obtained inkjet ink 1 or inkjet ink 2 was loaded into the image forming apparatus described above. As the inkjet head of the image forming apparatus, an inkjet head including a piezoelectric inkjet nozzle was used. The inkjet ink 1 or the inkjet ink 2 was ejected onto A4 size coated paper (OK Kinfuji, grammage of 104.7 g/m², manufactured by Oji Paper Co., Ltd.) by the image forming apparatus loaded with the inkjet ink 1 or the inkjet ink 2 in such a way that a solid image was formed (a step of ejecting the inkjet ink onto a recording sheet). Next, the inkjet ink was irradiated with active rays (ultraviolet rays) under the conditions listed in Table 1 (a step of curing the inkjet ink). The conveyance speed of the recording medium was 50 m/minute.

### Evaluation

### Evaluation of Show-Through Resistance

The density of the ink that had passed through to the back surface of each of the obtained solid images was measured with a fluorescence spectrophotometer FD-7 (manufactured by Konica Minolta, Inc). It was evaluated according to the following criteria. The larger the numerical value of the following criteria, the better the result, and 3 and 4 were regarded as acceptable.
4: The ink density was 0.00 to 0.05
3: The ink density was 0.06 to 0.10
2: The ink density was 0.11 to 0.15
1: The ink density was 0.16 to 0.20

### Evaluation of Cutting Processability

Each of the obtained solid images was cut at the printed portion by using an automatic cutting machine (PC-P430, manufactured by Horizon Co., Ltd.). The cut portion on the acute angle side of the cutting blade was rubbed with a finger 10 times, and the peeling length was measured with an optical microscope (LV-100D manufactured by Nikon Corporation). Note that the peeling length refers to the distance from the end surface (edge of the sheet surface) of the place where the cutting blade is inserted to the ink printed surface. It was evaluated according to the following criteria. Note that the shorter the peeling length, the better the result, and 3 and 4 were regarded as acceptable.
4: Peeling length is less than 10 μm (peeling cannot be visually recognized, there is no problem in practical use)
3: Peeling length is 10 μm or more and less than 80 μm (peeling cannot be visually recognized, there is no problem in practical use)
2: Peeling length is 80 μm or more and less than 200 μm (peeling is visible)
1: Peeling length is 200 μm or more (peeling is visible)

Conditions of the step of curing the inkjet ink and evaluation results are listed in Table 1.

TABLE 1

| | | | | | | | | Total | | |
|---|---|---|---|---|---|---|---|---|---|---|
| | Gelling agent | Upstream side | | | Downstream side | | | value of | | |
| | addition | Integrated | Integrated | | Integrated | Integrated | | integrated | Evaluation result | |
| | amount | light | light | Maximum | light | light | Maximum | light | Show- | |
| | (% by | amount | amount | irradiance | amount | amount | irradiance | amount | through | Causing |
| | mass) | (mJ/cm²) | ratio (%) | (W/cm²) | (mJ/cm²) | ratio (%) | (W/cm²) | (mJ/cm²) | resistance | processability |
| Example 1-1 | 5 | 132.0 | 33 | 0.0500 | 268.0 | 67 | 7.00 | 400 | 3 | 4 |
| Example 1-2 | 5 | 125.0 | 25 | 0.9000 | 375.0 | 75 | 5.00 | 500 | 4 | 4 |
| Example 1-3 | 5 | 66.0 | 33 | 0.0100 | 134.0 | 67 | 4.00 | 200 | 3 | 4 |
| Example 1-4 | 5 | 66.0 | 33 | 0.0100 | 134.0 | 67 | 8.00 | 200 | 3 | 3 |
| Example 1-5 | 5 | 195.0 | 39 | 1.5000 | 305.0 | 61 | 4.00 | 500 | 4 | 3 |
| Example 1-6 | 5 | 195.0 | 30 | 0.0050 | 455.0 | 70 | 9.00 | 650 | 3 | 3 |
| Example 1-7 | 5 | 132.0 | 18 | 0.0500 | 268.0 | 82 | 7.00 | 400 | 4 | 3 |
| Example 1-8 | 5 | 154.0 | 28 | 0.0700 | 396.0 | 72 | 6.00 | 550 | 3 | 4 |
| Example 1-9 | 5 | 79.2 | 33 | 2.0000 | 160.8 | 67 | 3.50 | 240 | 3 | 4 |
| Example 1-10 | 5 | 90.0 | 45 | 1.7000 | 110.0 | 55 | 3.80 | 220 | 4 | 3 |
| Example 1-11 | 5 | 54.0 | 30 | 0.0075 | 126.0 | 70 | 2.50 | 180 | 4 | 3 |
| Comparative | 5 | 200.0 | 50 | 1.0000 | 200.0 | 50 | 1.00 | 400 | 2 | 2 |
| Example 1-1 | | | | | | | | | | |
| Comparative | 0 | 200.0 | 50 | 1.0000 | 200.0 | 50 | 1.00 | 400 | 2 | 1 |
| Example 1-2 | | | | | | | | | | |
| Comparative | 5 | 240.0 | 60 | 1.2000 | 160.0 | 40 | 1.60 | 400 | 2 | 2 |
| Example 1-3 | | | | | | | | | | |
| Comparative | 5 | 360.0 | 90 | 1.8000 | 40.0 | 10 | 0.01 | 400 | 1 | 2 |
| Example 1-4 | | | | | | | | | | |
| Comparative | 5 | 60.0 | 60 | 0.0200 | 40.0 | 40 | 0.01 | 100 | 1 | 2 |
| Example 1-5 | | | | | | | | | | |
| Comparative | 5 | 560.0 | 70 | 2.9000 | 240.0 | 30 | 1.20 | 800 | 2 | 2 |
| Example 1-6 | | | | | | | | | | |

### Evaluation Result

As shown in Table 1, the show-through resistance and the cutting processability were satisfactory in the image forming methods of Examples 1-1 to 1-11 in which the integrated amount of active rays in the downstream portion was greater than the integrated amount of active rays in the upstream portion.

Further, the image forming methods of Examples 1-7 to 1-11 having the following feature showed more satisfactory show-through resistance or cutting processability than Example 6—the feature is as follows: the ratio of the integrated amount of active rays in the upstream portion to the integrated amount of active rays in the downstream portion was 20:80 to 40:60, the total integrated amount of active ray was in the range of 200 mJ/cm² or more and less than 500 mJ/cm², the maximum irradiance of active ray in the upstream portion was in the range of 0.01 W/cm² or more and less than 1.5 W/cm², or the maximum irradiance of active ray in the downstream portion was in the range of 4 W/cm² or more and less than 8 W/cm².

Furthermore, the image forming methods of Examples 1-1 to 1-5 having the following features showed more satisfactory show-through resistance or cutting processability than Example 6—the features are as follows: the ratio of the integrated amount of active rays in the upstream portion to the integrated amount of active rays in the downstream portion was 20:80 to 40:60, the total integrated amount of active ray was in the range of 200 mJ/cm² or more and less than 500 mJ/cm², the maximum irradiance of active ray in the upstream portion was in the range of 0.01 W/cm² or more and less than 1.5 W/cm², and the maximum irradiance of active ray in the downstream portion was in the range of 4 W/cm² or more and less than 8 W/cm².

On the other hand, the show-through resistance and the cutting processability were unsatisfactory in the image forming methods of Comparative Examples 1-1 to 1-6 in which the integrated amount of active rays in the downstream portion was less than the integrated amount of active rays in the upstream portion.

### Example/Comparative Example Related to Second Disclosure

### 1. Preparation/Synthesis of Materials

The materials used for preparing the active ray curable inkjet ink are shown below.

### 1-1. Pigment Dispersion Liquid

Nine parts by mass of a pigment dispersant (EFKA-7701, manufactured by BASF) and 71 parts by mass of tripropylene glycol diacrylate were placed in a stainless steel beaker, and the mixture was stirred for 1 hour while being heated to 65 °C on a hot plate. Then, the mixture was cooled to room temperature, and 20 parts by mass of any one of the pigments below was added into the stainless steel beaker after stirring, and then the mixture was placed in a glass bottle together with 200 g zirconia beads (diameter: 0.5 mm, manufactured by NIKKATO CORPORATION) and the glass bottle was hermetically sealed. This pigment-containing liquid was subjected to dispersion treatment using a paint shaker, and then the zirconia beads were removed to obtain a pigment dispersion liquid. Note that the time for the dispersion treatment was 4 hours when the cyan pigment and the black pigment were used, and 6 hours when the magenta pigment and the yellow pigment were used.
Cyan pigment (C pigment): Pigment Blue 15:4 (Chromofine Blue 6332JC, manufactured by Dainichiseika Color & Chemicals Mfg. Co., Ltd)
Magenta pigment (M pigment): mixed crystals of Pigment Violet 19 and Red 202 (CINQUASIA MAGENTA RT-355D, manufactured by BASF)
Yellow pigment (Y pigment): Pigment Yellow 185 (manufactured by BASF Corporation, D1155)
Black pigment (K pigment): Pigment Black 7 (#52, manufactured by Mitsubishi Chemical Corporation)

### 1-2. Active Ray Polymerizable Compound

m1: Polyester acrylate (ETERCURE6361-100: Long-Life Materials Industry) (octafunctional, number of EO groups: 8, repeating number of EO groups (average): 1, molecular weight of 561, acrylic equivalent: 70 g/eq, melting point: less than 25 °C)
m2: Tripropylene glycol diacrylate (EM223, manufactured by Eternal Materials Co., Ltd.) (bifunctional, number of PO groups: 3, repeating number of PO groups (average): 3, molecular weight: 300, acrylic equivalent: 150 g/eq, melting point: less than 25 °C)
m3: Polyester acrylate oligomer (CN2270NS, manufactured by Arkema) (bifunctional, number of PO groups: 5, repeating number of PO groups (average): 2.5, molecular weight: 692, acrylic equivalent: 251 g/eq, melting point: less than 25 °C)
m4: 3EO modified trimethylolpropane triacrylate (EM2382, manufactured by Eternal Materials Co., Ltd.) (trifunctional, number of EO groups: 9, repeating number of EO groups (average): 3, molecular weight: 692, acrylic equivalent: 231 g/eq, melting point: less than 25 °C)
m5: 14EO modified polyethylene glycol diacrylate #600 (M286, manufactured by Miwon) (bifunctional, number of EO groups: 14, repeating number of EO groups (average): 14, molecular weight: 708, acrylic equivalent: 354 g/eq, melting point: less than 25 °C)
m6: 3PO modified trimethylolpropane triacrylate (M360, manufactured by Miwon Corporation) (trifunctional, number of PO groups: 3, repeating number of PO groups (average): 1, molecular weight: 470, acrylic equivalent: 157 g/eq, melting point: less than 25 °C)
m7: 4EO modified nonylphenol acrylate (M164: manufactured by Miwon) (number of EO groups: 4, repeating number of EO groups (average): 4, molecular weight: 450, acrylic equivalent: 450 g/eq, melting point: less than 25 °C)
m8: lauryl acrylate (D4129 (LA): manufactured by Tokyo Chemical Industry Co., Ltd) (monofunctional: number of EO groups or PO groups: 0, molecular weight: 240, acrylic equivalent: 240 g/eq, melting point: less than 25 °C)
m9: 4EO modified phenol acrylate (M144, manufactured by Miwon Corporation) (monofunctional, number of EO groups: 4, repeating number of EO groups (average): 4, molecular weight: 324, acrylic equivalent: 324 g/eq, melting point: lower than 25 °C)
m10: 3PO modified glyceryl triacrylate (SR9020NS, manufactured by Arkema) (trifunctional, number of PO groups: 3, repeating number of PO groups (average): 1, molecular weight of 429, acrylic equivalent: 143 g/eq, melting point: less than 25 °C)
m11: Octadecyl acrylate (manufactured by SR9020NS: manufactured by Osaka Organic Chemical Industry Ltd)
   (monofunctional: number of EO groups or PO groups: 0, molecular weight: 324, acrylic equivalent: 324 g/eq, melting point: 30 °C)
m12: 8EO modified nonylphenol acrylate (M166, manufactured by Miwon) (monofunctional, number of EO groups: 8, repeating number of EO groups (average): 8, molecular weight: 626, acrylic equivalent: 624 g/eq, melting point: lower than 25 °C)
m13: Decanediol diacrylate (DOD-N: manufactured by Shin-Nakamura Chemical Co., Ltd) (bifunctional, number of EO groups or PO groups: 0, molecular weight: 282, acrylic equivalent: 141 g/eq, melting point: less than 25 °C)
m14: Tricyclodecane dimethanol diacrylate (A-DCP, manufactured by Shin-Nakamura Chemical Co., Ltd) (bifunctional, number of EO groups or PO groups: 0, molecular weight: 304, acrylic equivalent: 152 g/eq, melting point: less than 25 °C)
m15: 9EO modified trimethylolpropane triacrylate (M3190: manufactured by Miwon) (trifunctional, number of EO groups: 9, repeating number of EO groups (average): 3, molecular weight: 693, acrylic equivalent: 231 g/eq, melting point: less than 25 °C)
m16: Ditrimethylolpropane tetraacrylate (SR355, manufactured by Arkema) (tetrafunctional, number of EO groups or PO groups: 0, molecular weight: 466, acrylic equivalent: 117 g/eq, melting point: less than 25 °C)
m17: 2.5PO Modified nonylphenol acrylate (EM2181: manufactured by Eternal Materials Co., Ltd.) (monofunctional, number of PO groups: 2.5, repeating number of PO group (average): 2.5, molecular weight: 419, acrylic equivalent: 419 g/eq, melting point: less than 25 °C)
m18: (5-Ethyl-1,3-dioxane-5-yl) methyl acrylate (E1334, Tokyo Chemical Industry Co., Ltd) (monofunctional, number of EO groups or PO groups: 0, molecular weight: 200, acrylic equivalent: 200 g/eq, melting point: less than 25 °C)
m19: isobornyl acrylate (IBXA, manufactured by Osaka Organic Chemical Industry Ltd) (monofunctional, number of EO groups or PO groups: 0, molecular weight: 208, acrylic equivalent: 208 g/eq, melting point: less than 25 °C)
m20: Tris(2-acryloyloxyethyl) isocyanurate (T2325: manufactured by Tokyo Chemical Industry Co., Ltd) (trifunctional, number of EO groups or PO groups: 0, molecular weight: 423, acrylic equivalent: 141 g/eq, melting point: 53 °C)
m21: 3.5PO Modified glyceryl triacrylate (EM2387, manufactured by Eternal Materials Co., Ltd.) (trifunctional, number of EO groups or PO groups: 3.5, molecular weight: 458, acrylic equivalent: 153 g/eq, melting point: lower than 25 °C)
m22: 3EO modified glyceryl triacrylate (EM2388, manufactured by Eternal Materials Co., Ltd.) (trifunctional, number of EO groups or PO groups: 3, molecular weight: 386, acrylic equivalent: 129 g/eq, melting point: lower than 25 °C)
m23: 6PO modified glyceryl triacrylate (MX-1: synthesized product synthesized by a known method) (trifunctional, number of EO groups or PO groups: 6, molecular weight: 603, acrylic equivalent: 201 g/eq, melting point: lower than 25 °C)
m24: 2EO modified phenol acrylate
   (monofunctional, number of EO groups: 2, repeating number of EO groups (average): 2, molecular weight: 236, acrylic equivalent: 236 g/eq, melting point: lower than 25 °C)
m25: 2EO modified phenol acrylate
   (monofunctional, number of EO groups: 2, repeating number of EO groups (average): 2, molecular weight: 236, acrylic equivalent: 236 g/eq, melting point: lower than 25 °C)

Among the photopolymerizable compounds, the melting points of m11 and m20 are catalog values, and the melting points of the other photopolymerizable compounds are determined as less than 25 °C by confirming that the compounds are liquid at room temperature (25 °C).

### 1-3. Gelling Agent

G1: Behenyl behenate (WEP-3, manufactured by NOF Corporation)
G2: Stearyl stearate (Exepearl SS, manufactured by Kao Corporation)

### 1-4. Photopolymerization Initiator

Initiator 1 (Omnirad 819, IGM Resins B.V.)
Initiator 2 (Speedcure 2-ITX, manufactured by Arkema)

### 1-5. Polymerization Inhibitor

Irgasutab UV-10 (manufactured by BASF)

### 1-6. Surfactant

KF-352A (manufactured by Shin-Etsu Chemical Co., Ltd)

### 2. Preparation of Active Ray Curable Inkjet Ink

A pigment dispersion liquid, an active ray polymerizable compound, a gelling agent, a polymerization initiator, a polymerization inhibitor, and a surfactant were placed in a stainless steel beaker so as to achieve the composition shown in Tables 2 to 6, and the mixture was stirred at 105 °C for 45 minutes. Thereafter, the mixture was filtered through a Teflon (registered trademark) 3-um membrane filter produced by ADVANTEC to obtain active ray curable inkjet inks (ink D1 to D4 and ink E1 to E19).

TABLE 2

| Ink | | D1 | D2 | D3 | D4 |
|---|---|---|---|---|---|
| Pigment | C pigment | 2 | 2 | 2 | 2 |
| | M pigment | | | | |
| | Y pigment | | | | |
| | K pigment | | | | |
| Pigment dispersant | | 0.88 | 0.88 | 0.88 | 0.88 |
| Active ray | Initiator 1 | 3 | 3 | 3 | 3 |
| polymerization | Initiator 2 | 0.5 | 0.5 | 0.5 | 0.5 |
| initiator | | | | | |
| Polymerization inhibitor | | 0.1 | 0.1 | 0.1 | 0.1 |
| Surfactant | | 0.1 | 0.1 | 0.1 | 0.1 |
| Gelling | G1 | 1.5 | 1.5 | 1.5 | 1.5 |
| agent | G2 | 2.2 | 2.2 | 2.2 | 2.2 |
| Monomer | m1 | | 8 | | |
| | m2 | 18 | 20 | 20 | 18 |
| | m3 | | | | |
| | m4 | 30.72 | | 18 | 18 |
| | m5 | 41 | | 13 | 12.72 |
| | m6 | | 18.72 | | 18 |
| | m7 | | | | |
| | m8 | | | | |
| | m9 | | | 8 | 18 |
| | m10 | | | | |
| | m11 | | | 10 | |
| | m12 | | | | |
| | m13 | | | | |
| | m14 | | 28 | | |
| | m15 | | | | |
| | m16 | | | | |
| | m17 | | | | |
| | m18 | | 5 | 20.72 | |
| | m19 | | 10 | | |
| | m20 | | | | 5 |
| | m21 | | | | |
| | m22 | | | | |
| | m23 | | | | |
| | m24 | | | | |
| | m25 | | | | |

| | | | | |
|---|---|---|---|---|
| Total | 100 | 100 | 100 | 100 |
| Total of monomers | 89.72 | 89.72 | 89.72 | 89.72 |

TABLE 3

| Ink | | E1 | E2 | E3 | E4 | E5 |
|---|---|---|---|---|---|---|
| Pigment | C pigment | 2 | 2 | | 2 | |
| | M pigment | | | | | |
| | Y pigment | | | | | |
| | K pigment | | | 2 | | 2 |
| Pigment dispersant | | 0.88 | 0.88 | 0.88 | 0.88 | 0.88 |
| Active ray | Initiator 1 | 3 | 3 | 3 | 3 | 3 |
| polymer- | Initiator 2 | 0.5 | 0.5 | 0.5 | 0.5 | 0.5 |
| ization | | | | | | |
| initiator | | | | | | |
| Polymerization inhibitor | | 0.1 | 0.1 | 0.1 | 0.1 | 0.1 |
| Surfactant | | 0.1 | 0.1 | 0.1 | 0.1 | 0.1 |
| Gelling | G1 | 1.5 | 1.5 | 1.5 | 1.5 | 1.5 |
| agent | G2 | 2.2 | 2.2 | 2.2 | 2.2 | 2.2 |
| Monomer | m1 | 4 | | | | 7 |
| | m2 | 20 | 20 | 20 | 20 | 20 |
| | m3 | | 4 | 6 | 15 | |
| | m4 | 5 | | 14 | | 17 |
| | m5 | 29 | 20 | 16 | 10 | 8 |
| | m6 | 1.72 | 2.72 | 4 | 19.72 | 10.72 |
| | m7 | | 5 | | | 7 |
| | m8 | | | | | |
| | m9 | | 10 | | | 5 |
| | m10 | 6 | | | | 15 |
| | m11 | | | | | |
| | m12 | 19 | 15 | | | |
| | m13 | | 5 | 10 | | |
| | m14 | 5 | | | | |
| | m15 | | 8 | | 7 | |
| | m16 | | | | | |
| | m17 | | | | 18 | |
| | m18 | | | 19.72 | | |
| | m19 | | | | | |
| | m20 | | | | | |
| | m21 | | | | | |
| | m22 | | | | | |
| | m23 | | | | | |
| | m24 | | | | | |
| | m25 | | | | | |

| | | | | | |
|---|---|---|---|---|---|
| Total | 100 | 100 | 100 | 100 | 100 |
| Total of monomers | 89.72 | 89.72 | 89.72 | 89.72 | 89.72 |

TABLE 4

| Ink | | E6 | E7 | E8 | E9 | E10 |
|---|---|---|---|---|---|---|
| Pigment | C pigment | | 2 | | | |
| | M pigment | | | | 2 | |
| | Y pigment | | | | | 2 |
| | K pigment | 2 | | 2 | | |
| Pigment dispersant | | 0.88 | 0.88 | 0.88 | 0.88 | 0.88 |
| Active ray | Initiator 1 | 3 | 3 | 3 | 3 | 3 |
| polymer- | Initiator 2 | 0.5 | 0.5 | 0.5 | 0.5 | 0.5 |
| ization | | | | | | |
| initiator | | | | | | |
| Polymerization inhibitor | | 0.1 | 0.1 | 0.1 | 0.1 | 0.1 |
| Surfactant | | 0.1 | 0.1 | 0.1 | 0.1 | 0.1 |
| Gelling | G1 | 1.5 | 1.5 | 1.5 | 1.5 | 1.5 |
| agent | G2 | 2.2 | 2.2 | 2.2 | 2.2 | 2.2 |
| Monomer | m1 | 11 | | 8 | | 8.5 |
| | m2 | 22 | 20 | 22 | 25 | 22 |
| | m3 | 1 | 9 | 1.5 | 13 | 4 |
| | m4 | 16.5 | 21 | 11 | 10.22 | 19.22 |
| | m5 | 11 | 12 | 9.22 | 4 | |
| | m6 | 5.22 | | | | |
| | m7 | 5 | 6 | 4.5 | 6 | |
| | m8 | | | | | |
| | m9 | 4 | 5 | 9 | 13.5 | 20 |
| | m10 | 14 | 16.72 | 18.5 | 18 | 4 |
| | m11 | | | | | |
| | m12 | | | | | |
| | m13 | | | | | |
| | m14 | | | | | |
| | m15 | | | | | |
| | m16 | | | | | |
| | m17 | | | | | |
| | m18 | | | | | |
| | m19 | | | | | |
| | m20 | | | | | |
| | m21 | | | | | 12 |
| | m22 | | | | | |
| | m23 | | | | | |
| | m24 | | | | | |
| | m25 | | | 6 | | |

| | | | | | |
|---|---|---|---|---|---|
| Total | 100 | 100 | 100 | 100 | 100 |
| Total of monomers | 89.72 | 89.72 | 89.72 | 89.72 | 89.72 |

TABLE 5

| Ink | | E11 | E12 | E13 | E14 | E15 |
|---|---|---|---|---|---|---|
| Pigment | C pigment | | 2 | 2 | | 2 |
| | M pigment | 2 | | | | |
| | Y pigment | | | | | |
| | K pigment | | | | 2 | |
| Pigment dispersant | | 0.88 | 0.88 | 0.88 | 0.88 | 0.88 |
| Active ray | Initiator 1 | 3 | 3 | 3 | 3 | 3 |
| polymer- | Initiator 2 | 0.5 | 0.5 | 0.5 | 0.5 | 0.5 |
| ization | | | | | | |
| initiator | | | | | | |
| Polymerization inhibitor | | 0.1 | 0.1 | 0.1 | 0.1 | 0.1 |
| Surfactant | | 0.1 | 0.1 | 0.1 | 0.1 | 0.1 |
| Gelling | G1 | 1.5 | 1.5 | 1.5 | 1.5 | 1.5 |
| agent | G2 | 2.2 | 2.2 | 2.2 | 2.2 | 2.2 |
| Monomer | m1 | | | | 4.8 | 1.7 |
| | m2 | 25 | 20 | 20 | 24 | 20 |
| | m3 | 13 | 2.72 | 3.72 | | |
| | m4 | 11 | | | | |
| | m5 | 3.52 | 11 | 10 | | 10 |
| | m6 | | 18 | 18 | 15.82 | 17.52 |
| | m7 | 5.5 | 10 | 8 | | 16.5 |
| | m8 | | | | | |
| | m9 | 13 | | | | 4 |
| | m10 | 18.7 | 4 | 12 | 45.1 | 20 |
| | m11 | | | | | |
| | m12 | | | | | |
| | m13 | | | | | |
| | m14 | | | | | |
| | m15 | | | | | |
| | m16 | | | | | |
| | m17 | | | | | |
| | m18 | | | | | |
| | m19 | | | | | |
| | m20 | | | | | |
| | m21 | | | 18 | | |
| | m22 | | 4 | | | |
| | m23 | | 20 | | | |
| | m24 | | | | | |
| | m25 | | | | | |

| | | | | | |
|---|---|---|---|---|---|
| Total | 100 | 100 | 100 | 100 | 100 |
| Total of monomers | 89.72 | 89.72 | 89.72 | 89.72 | 89.72 |

TABLE 6

| Ink | | E16 | E17 | E18 | E19 |
|---|---|---|---|---|---|
| Pigment | C pigment | | | | 2 |
| | M pigment | | | 2 | |
| | Y pigment | 2 | 2 | | |
| | K pigment | | | | |
| Pigment dispersant | | 0.88 | 0.88 | 0.88 | 0.88 |
| Active ray | Initiator 1 | 3 | 3 | 3 | 3 |
| polymer- | Initiator 2 | 0.5 | 0.5 | 0.5 | 0.5 |
| ization | | | | | |
| initiator | | | | | |
| Polymerization inhibitor | | 0.1 | 0.1 | 0.1 | 0.1 |
| Surfactant | | 0.1 | 0.1 | 0.1 | 0.1 |
| Gelling | G1 | 1.5 | 1.5 | 1.5 | 1.5 |
| agent | G2 | 2.2 | 2.2 | 2.2 | 2.2 |
| Monomer | m1 | 8 | 10 | 1 | 10 |
| | m2 | 21.5 | 20 | 20 | 20 |
| | m3 | | | 2.5 | |
| | m4 | | 6 | 5 | 18.72 |
| | m5 | | 2 | 3 | 11 |
| | m6 | 10.02 | 9.72 | 12.22 | |
| | m7 | | 2 | | |
| | m8 | | | | |
| | m9 | 17.2 | 12 | 10 | |
| | m10 | 33 | 28 | 22 | |
| | m11 | | | | |
| | m12 | | | 6 | |
| | m13 | | | | |
| | m14 | | | | |
| | m15 | | | | |
| | m16 | | | | |
| | m17 | | | | |
| | m18 | | | | |
| | m19 | | | | |
| | m20 | | | | |
| | m21 | | | | |
| | m22 | | | 8 | |
| | m23 | | | | 30 |
| | m24 | | | | |
| | m25 | | | | |

| | | | | |
|---|---|---|---|---|
| Total | 100 | 100 | 100 | 100 |
| Total of monomers | 89.72 | 89.72 | 89.72 | 89.72 |

### 3. Image Formation

Using one of the inkjet inks D1 to D4 and E1 to E19, a single-color image was formed with a line type inkjet recording apparatus. The temperature of the inkjet head of the inkjet recording apparatus was set to 80 °C. A solid image of 5 cm×5 cm was printed on recording media (OK Top Coat+127 g, manufactured by Oji Paper Co., Ltd). As the recording head for ejection, a piezo head was used. The ejection conditions were such that the amount of one droplet was 9.0 μl, and the ink was ejected at a droplet speed of about 6 m/s and recorded at 1200 dpi ×1200 dpi resolutions. The recording speed was set to 500 mm/s. The image formation was performed in an environment of 23 °C and 55% RH. Dpi represents the number of dots per inch (2.54 cm). After the image was formed, the recording medium was irradiated with ultraviolet rays by a preliminary irradiation section and a main irradiation section each having an LED lamp (395 nm, water-cooled LED, manufactured by Phoseon Technology, Inc) disposed in a downstream portion of the recording apparatus.

There were seven irradiation conditions, A, B, and C-1 to C-5, as shown in the following Table 7. A and B are the irradiation conditions of comparative examples, and C1-1 to C-5 are the irradiation conditions of examples. Note that the irradiance distributions of C-1 to C-5 are such that the irradiance gradually increases in the preliminary irradiation and has a peak in the main irradiation as illustrated in FIG. 2B.

TABLE 7

| | Integrated light | | |
|---|---|---|---|
| | amount ratio [%] | | |
| | First half | Second half | Total |
| | (preliminary | (main | integrated |
| | irradiation | irradiation | light amount |
| Irradiance distribution | section) L1 | section) L2 | [mJ/cm²] |
| A (Comparative example) | 50 | 50 | 700 |
| B (Comparative example) | 50 | 50 | 200 |
| C-1 (Example) | 10 | 90 | 700 |
| C-2 (Example) | 20 | 80 | 700 |
| C-3 (Example) | 30 | 70 | 700 |
| C-4 (Example) | 40 | 60 | 700 |
| C-5 (Example) | 30 | 70 | 500 |

### 4. Evaluation

### (Cracking by Folding)

The image formed on the recording medium was mountain-folded using a paper folder (AFV-564FKT, manufactured by Horizon Co., Ltd.). Thereafter, the state of the image was observed, and the proportion of the area of a portion where exposure of the recording medium due to cracking did not occur (unexposed portion) was obtained by image analysis. The folding crack resistance was evaluated according to the following criteria. The folding crack resistance is preferably 3 or more.
5: No crack of the image was confirmed
4: Cracks were confirmed in the image, and exposure of the white background was slight
3: Cracks were confirmed in the image, and the white background was exposed in a region less than half of the image
2: Cracks were confirmed in the image, and the white background was exposed in a region half or more of the area
1: Cracks were confirmed in the image, and the white background was exposed in the entire region of the image

### (Abrasion Resistance (Scratch Resistance))

The lens-shaped molded article made of polycarbonate was rubbed back and forth 15 times against the image formed on the recording medium while applying each load shown below, and the load at which the image was peeled off was recorded. The loads were set to 200 g, 250 g, 300 g, 350 g, and 400 g. The abrasion resistance is preferably 250 g or more.

(Tape Peelability (Internal Curability)) A tape manufactured by NICHIBAN CO., LTD. was attached to the image formed on a recording medium, and after 10 reciprocating motions with a roller having a load of 500 g, the tape was peeled off and the peeled area of the formed image was confirmed. It was evaluated according to the following criteria. The tape peelability is preferably 3 or more.
4: No peeling
3: Very slight peeling
2: Peeling in half image
1: Peeling in the entire image

### (Injection Properties)

Regarding the image output matter of each sample, it was visually confirmed whether or not there was a streak of a white spot (white streak due to ejection failure) in the 100% printed portion at the time of printing on the 10th sheet and the 100th sheet.
3: There was no white spots, or there was one or two white spots, but it was at a level that did not cause any problems in practical use
2: There were five or fewer white spots, which was an acceptable level for practical use
1: There were many white spots, which caused practical problems

### (Viscosity)

The viscosities of the inks D1 to D4 and the inks E1 to E19 at 60 °C were obtained. The viscosity was determined from a complex viscosity when the temperature reached 60 °C in a viscosity change curve measured while changing the temperature from 90 °C to 30 °C in an oscillation mode using a Modular Compact Rheometer (MCR 302e, manufactured by Anton Paar). Based on the measured viscosity, evaluation was performed according to the following criteria.
2: Viscosity was 10 to 25 mPa·s
1: Viscosity was outside the range of 10 to 25 mPa·s

The evaluation results are collectively presented in Tables 8 to 14. The parameters of each ink used are also shown.

TABLE 8

| | Comparative | Comparative | Comparative | Comparative | Comparative |
|---|---|---|---|---|---|
| | example | example | example | example | example |
| | 2-1 | 2-2 | 2-3 | 2-4 | 2-5 |
| UV | A | A | B | B | C-3 |
| irradiation conditions | | | | | |
| Ink | Ink E1 | ink E7 | Ink E1 | Ink E7 | Ink D1 |
| Number of functional groups | 2.2 | 2.3 | 2.2 | 2.3 | 2.3 |
| Molecular weight | 546.6 | 502.0 | 546.6 | 502.0 | 620.7 |
| Acrylic equivalent | 317.5 | 234.8 | 317.5 | 234.8 | 270.9 |
| EO | 7.1 | 4.5 | 7.1 | 4.5 | 9.5 |
| modification number | | | | | |
| PO | 0.9 | 1.7 | 0.9 | 1.7 | 0.6 |
| modification number | | | | | |
| EO + PO | 8.0 | 6.2 | 8.0 | 6.2 | 10.1 |
| modification number | | | | | |
| Glycerol skeleton + benzene ring | 25 | 27.72 | 25 | 27.72 | 0 |
| Benzene ring | 19 | 11 | 19 | 11 | 0 |
| Glycerol skeleton | 6 | 16.72 | 6 | 16.72 | 0 |
| Polymerizable compound having melting | 0 | 0 | 0 | 0 | 0 |
| point of 25 °C or higher based on total | | | | | |
| mass of polymerizable compound | | | | | |
| Cracking by folding | 2 | 2 | 3 | 3 | 5 |
| Abrasion resistance | 200 | 350 | 200 | 200 | 200 |
| Tape peeling | 4 | 4 | 1 | 2 | 4 |
| Ejection properties | 3 | 3 | 3 | 3 | 3 |
| Viscosity | 2 | 2 | 2 | 2 | 2 |

TABLE 9

| | Compar- | Compar- | Compar- |
|---|---|---|---|
| | ative | ative | ative |
| | example | example | example |
| | 2-6 | 2-7 | 2-8 |
| UV | C-3 | C-3 | C-3 |
| irradiation conditions | | | |
| Ink | Ink D2 | Ink D3 | Ink D4 |
| Number of functional groups | 2.6 | 1.8 | 2.3 |
| Molecular weight | 344.4 | 419.7 | 482.4 |
| Acrylic equivalent | 154.3 | 242.3 | 230.9 |
| EO | 0.7 | 4.2 | 4.6 |
| modification number | | | |
| PO | 1.3 | 0.7 | 1.2 |
| modification number | | | |
| EO + PO | 2.0 | 4.9 | 5.8 |
| modification number | | | |
| Glycerol skeleton + benzene ring | 0 | 8 | 18 |
| Benzene ring | 0 | 8 | 18 |
| Glycerol skeleton | 0 | 0 | 0 |
| Mass % of polymerizable compound | 0 | 11.1 | 5.57 |
| having melting point of 25 °C | | | |
| or higher based on total mass | | | |
| of polymerizable compound | | | |
| Cracking by folding | 1 | 2 | 2 |
| Abrasion resistance | 400 | 200 | 250 |
| Tape peeling | 4 | 4 | 4 |
| Ejection properties | 3 | 1 | 1 |
| Viscosity | 2 | 2 | 2 |

TABLE 10

| | Example | Example | Example | Example | Example |
|---|---|---|---|---|---|
| | 2-1 | 2-2 | 2-3 | 2-4 | 2-5 |
| UV | C-1 | C-2 | C-3 | C-4 | C-5 |
| irradiation conditions | | | | | |
| Ink | Ink E7 | Ink E7 | Ink E7 | Ink E7 | Ink E7 |
| Number of functional groups | 2.3 | 2.3 | 2.3 | 2.3 | 2.3 |
| Molecular weight | 502.0 | 502.0 | 502.0 | 502.0 | 502.0 |
| Acrylic equivalent | 234.8 | 234.8 | 234.8 | 234.8 | 234.8 |
| EC | 4.5 | 4.5 | 4.5 | 4.5 | 4.5 |
| modification number | | | | | |
| PC | 1.7 | 1.7 | 1.7 | 1.7 | 1.7 |
| modification number | | | | | |
| EO + PO | 6.2 | 6.2 | 6.2 | 6.2 | 6.2 |
| modification number | | | | | |
| Glycerol skeleton + benzene ring | 27.72 | 27.72 | 27.72 | 27.72 | 27.72 |
| Benzene ring | 11 | 11 | 11 | 11 | 11 |
| Glycerol skeleton | 16.72 | 16.72 | 16.72 | 16.72 | 16.72 |
| Polymerizable compound | 0 | 0 | 0 | 0 | 0 |
| having melting point of 25 °C | | | | | |
| or higher based on total mass | | | | | |
| of polymerizable compound | | | | | |
| Cracking by folding | 4 | 4 | 4 | 3 | 4 |
| Abrasion resistance | 250 | 300 | 300 | 300 | 300 |
| Tape peeling | 4 | 4 | 4 | 4 | 4 |
| Ejection properties | 3 | 3 | 3 | 3 | 3 |
| Viscosity | 2 | 2 | 2 | 2 | 2 |

TABLE 11

| | Example | Example | Example | Example | Example |
|---|---|---|---|---|---|
| | 2-6 | 2-7 | 2-8 | 2-9 | 2-10 |
| UV | C-3 | C-3 | C-3 | C-3 | C-3 |
| irradiation conditions | | | | | |
| Ink | Ink E1 | ink E2 | ink E3 | ink E4 | ink E5 |
| Number of functional groups | 2.2 | 1.8 | 2.0 | 2.1 | 2.8 |
| Molecular weight | 546.6 | 504.8 | 431.2 | 471.3 | 485.9 |
| Acrylic equivalent | 317.5 | 322.7 | 216.1 | 251.5 | 210.0 |
| EO | 7.1 | 5.9 | 3.9 | 2.3 | 4.1 |
| modification number | | | | | |
| PO | 0.9 | 1.0 | 1.1 | 2.7 | 1.5 |
| modification number | | | | | |
| EO + PO | 8.0 | 6.9 | 5.0 | 4.9 | 5.6 |
| modification number | | | | | |
| Glycerol skeleton + benzene ring | 25 | 30 | 0 | 18 | 27 |
| Benzene ring | 19 | 30 | 0 | 18 | 12 |
| Glycerol skeleton | 6 | 0 | 0 | 0 | 15 |
| Polymerizable compound | 0 | 0 | 0 | 0 | 0 |
| having melting point of 25 °C | | | | | |
| or higher based on total mass | | | | | |
| of polymerizable compound | | | | | |
| Cracking by folding | 5 | 4 | 3 | 3 | 3 |
| Abrasion resistance | 250 | 250 | 250 | 300 | 300 |
| Tape peeling | 4 | 4 | 4 | 4 | 4 |
| Ejection properties | 3 | 3 | 3 | 3 | 3 |
| Viscosity | 2 | 2 | 2 | 2 | 2 |

TABLE 12

| | Example | Example | Example | Example | Example |
|---|---|---|---|---|---|
| | 2-11 | 2-12 | 2-13 | 2-14 | 2-15 |
| UV | C-3 | C-3 | C-3 | C-3 | C-3 |
| irradiation conditions | | | | | |
| Ink | ink E6 | ink E8 | ink E9 | ink E10 | ink E11 |
| Number of functional groups | 3.0 | 2.6 | 2.1 | 2.7 | 2.1 |
| Molecular weight | 495.8 | 448.8 | 431.7 | 449.9 | 433.0 |
| Acrylic equivalent | 205.0 | 212.2 | 227.8 | 203.1 | 224.7 |
| EO | 4.8 | 4.0 | 2.5 | 3.6 | 2.5 |
| modification number | | | | | |
| PO | 1.4 | 1.4 | 2.2 | 1.6 | 2.2 |
| modification number | | | | | |
| EO + PO | 6.2 | 5.4 | 4.7 | 5.1 | 4.7 |
| modification number | | | | | |
| Glycerol skeleton + benzene ring | 23 | 38 | 37.5 | 36 | 37.2 |
| Benzene ring | 9 | 19.5 | 19.5 | 20 | 18.5 |
| Glycerol skeleton | 14 | 18.5 | 18 | 16 | 18.7 |
| Polymerizable compound | 0 | 0 | 0 | 0 | 0 |
| having melting point of 25 °C | | | | | |
| or higher based on total mass | | | | | |
| of polymerizable compound | | | | | |
| Cracking by folding | 4 | 4 | 4 | 4 | 5 |
| Abrasion resistance | 300 | 400 | 350 | 350 | 350 |
| Tape peeling | 4 | 4 | 4 | 4 | 4 |
| Ejection properties | 3 | 3 | 3 | 3 | 3 |
| Viscosity | 2 | 2 | 2 | 2 | 2 |

TABLE 13

| | Example | Example | Example | Example | Example |
|---|---|---|---|---|---|
| | 2-16 | 2-17 | 2-18 | 2-19 | 2-20 |
| UV | C-3 | C-3 | C-3 | C-3 | C-3 |
| irradiation conditions | | | | | |
| Ink | ink E12 | ink E13 | ink E14 | ink E15 | ink E16 |
| Number of functional groups | 2.4 | 2.4 | 3.0 | 2.3 | 2.8 |
| Molecular weight | 484.2 | 450.2 | 408.6 | 441.0 | 394.2 |
| Acrylic equivalent | 223.0 | 204.6 | 143.3 | 233.9 | 174.4 |
| EO | 2.3 | 1.9 | 0.4 | 2.6 | 1.5 |
| modification number | | | | | |
| PO | 2.9 | 2.6 | 2.8 | 1.9 | 2.2 |
| modification number | | | | | |
| EO + PO | 5.2 | 4.5 | 3.3 | 4.5 | 3.6 |
| modification number | | | | | |
| Glycerol skeleton + benzene ring | 38 | 38 | 45.1 | 40.5 | 50.2 |
| Benzene ring | 10 | 8 | 0 | 20.5 | 17.2 |
| Glycerol skeleton | 28 | 30 | 45.1 | 20 | 33 |
| Polymerizable compound | 0 | 0 | 0 | 0 | 0 |
| having melting point of 25 °C | | | | | |
| or higher based on total mass | | | | | |
| of polymerizable compound | | | | | |
| Cracking by folding | 4 | 4 | 4 | 4 | 5 |
| Abrasion resistance | 350 | 400 | 400 | 400 | 400 |
| Tape peeling | 4 | 4 | 4 | 4 | 4 |
| Ejection properties | 3 | 3 | 3 | 3 | 3 |
| Viscosity | 2 | 2 | 2 | 2 | 2 |

TABLE 14

| | Example | Example | Example | Example | Example |
|---|---|---|---|---|---|
| | 2-21 | 2-22 | 2-23 | 2-24 | 2-25 |
| UV | C-3 | C-3 | C-5 | C-5 | C-3 |
| irradiation conditions | | | | | |
| Ink | ink E17 | ink E18 | ink E13 | ink E15 | ink E19 |
| Number of functional groups | 3.0 | 2.4 | 2.4 | 2.3 | 3.2 |
| Molecular weight | 429.5 | 431.0 | 450.2 | 441.0 | 562.3 |
| Acrylic equivalent | 179.5 | 211.8 | 204.6 | 233.9 | 200 |
| EO | 2.4 | 2.3 | 1.9 | 2.6 | 4.5 |
| modification number | | | | | |
| PO | 1.9 | 2.0 | 2.6 | 1.9 | 2.7 |
| modification number | | | | | |
| EO + PO | 4.4 | 4.3 | 4.5 | 4.5 | 7.2 |
| modification number | | | | | |
| Glycerol skeleton + benzene ring | 42 | 46 | 38 | 40.5 | 30 |
| Benzene ring | 14 | 16 | 8 | 20.5 | 0 |
| Glycerol skeleton | 28 | 30 | 30 | 20 | 30 |
| Polymerizable compound | 0 | 0 | 0 | 0 | 0 |
| having melting point of 25 °C | | | | | |
| or higher based on total mass | | | | | |
| of polymerizable compound | | | | | |
| Cracking by folding | 4 | 3 | 4 | 4 | 5 |
| Abrasion resistance | 400 | 400 | 400 | 400 | 300 |
| Tape peeling | 4 | 4 | 4 | 4 | 4 |
| Ejection properties | 3 | 3 | 3 | 3 | 2 |
| Viscosity | 2 | 2 | 2 | 2 | 1 |

As can be seen from Tables 8 to 14, it was found that an image less prone to cracking by folding and having high abrasion resistance and tape peelability (internal curability) can be formed by using the inks E and subjecting the inkjet ink to preliminary curing and full curing. Furthermore, the inks E1 to 18 had high ejection stability.

### INDUSTRIAL APPLICABILITY

With the image forming method according to the present invention, an ink can be ejected from an inkjet head with high precision. Therefore, accuracy of an image formed by the image forming method can be enhanced, which is useful, for example, in the field of image formation.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming method for forming, by using an inkjet ink of an active ray-curable type, an image on a recording medium conveyed from upstream to downstream, the inkjet ink containing a polymerizable compound, a photopolymerization initiator, and a gelling agent and undergoing phase transition depending on a temperature, the image forming method comprising:
ejecting the inkjet ink onto the recording medium; and
curing the inkjet ink by irradiating the inkjet ink with an active ray in an active ray irradiation region, the inkjet ink being ejected onto the recording medium being conveyed, wherein
in the curing the inkjet ink, when the active ray irradiation region is divided into two at a central portion of the active ray irradiation region in a conveyance direction of the recording medium, the active ray is applied in such a way that an integrated amount of the active ray in a downstream portion of the active ray irradiation region is larger than an integrated amount of the active ray in an upstream portion of the active ray irradiation region.

2. The image forming method according to claim 1, wherein
in the curing the inkjet ink, the inkjet ink is irradiated with the active ray in such a way that a ratio of the integrated amount of the active ray in the upstream portion to the integrated amount of the active ray in the downstream portion is 20:80 to 40:60.

3. The image forming method according to claim 1, wherein
in the curing the inkjet ink, a total value of the integrated amount of the active ray applied in the active ray irradiation region is within a range of 200 mJ/cm² or more and less than 500 mJ/cm².

4. The image forming method according to claim 1, wherein
in the curing the inkjet ink, maximum irradiance of the active ray in the upstream portion is in a range of 0.01 W/cm² or more and less than 1.5 W/cm², and maximum irradiance of the active ray in the downstream portion is in a range of 4 W/cm² or more and less than 8 W/cm².

5. The image forming method according to claim 1, wherein
a speed at which the recording medium is conveyed from upstream to downstream is 50 m/min or more.
